(19) United States
(12) Patent Application Publication
(10) Pub. No.: US 2025/0266917 A1
(43) Pub. Date: Aug. 21, 2025

(54) WIRELESS INTERFERENCE MITIGATION IN A NETWORK ENVIRONMENT

(71) Applicant: Charter Communications Operating, LLC, St. Louis, MO (US)

(72) Inventors: Muhammad Usman Fazili, Audubon, PA (US); Phillip B. Oni, Klein, TX (US); Marcus Maranhao, Irvine, CA (US); Yuda Y. Luz, Buffalo Grove, IL (US); Francisco A. Azcuy, Miami, FL (US); Dumitru M. lonescu, Poway, CA (US)

(21) Appl. No.: 19/053,003

(22) Filed: Feb. 13, 2025

Related U.S. Application Data
(60) Provisional application No. 63/554,807, filed on Feb. 16, 2024.

(51) Int. Cl. H04B 17/345; H04W 24/08; H04W 72/0446

(52) U.S. Cl. CPC H04B 17/345; H04W 24/08; H04W 72/0446

(57) ABSTRACT

A wireless communication system includes a first wireless station and a second wireless station. The first wireless station establishes wireless connectivity with multiple wireless stations including the second wireless station. The first wireless station transmits a first notification to the multiple wireless stations, where the first notification includes reference signal schedule information indicating a schedule for monitoring at least one reference signal. The first wireless station additionally transmits a second notification, where the second notification triggering the second wireless station to monitor the at least one reference signal as indicated by the reference signal schedule information.

### RELATED APPLICATION

This application claims the benefit of earlier filed U.S. Provisional Patent Application Ser. No. 63/554,807 entitled “CROSS-LINK INTERFERENCE MITIGATION IN SBFD NETWORKS,” (Attorney Docket No. CHTR-2024-36P), filed on Feb. 16, 2024, the entire teachings of which are incorporated herein by this reference.

### BACKGROUND

In a prior wireless proposed standard, there is an evaluation of a new feature called Sub-Band Full Duplex (SBFD), which allows a legacy TDD (Time Division Duplex) slot or symbol, which is configured as “Downlink” or “Flexible,” to have tones (Bandwidth (BW)) allocated for “Downlink” as well as for “Uplink” transmissions. In other words, SBFD enables both downlink and uplink wireless transmissions in a given time slot of a time slotted communication configuration.

In general, so-called gNBs (a.k.a., wireless base stations) may support half duplex communications in a TDD (Time Division Duplex) configuration and, alternatively, may support full duplex communications in a FDD (Frequency Division Duplex) configuration. In this latter case of implementing FDD, the gnBs can be configured to simultaneously receive and transmit wireless signals on the same carrier frequency. UEs are capable of half duplex communications in a TDD configuration and are capable of full duplex communications when in an FDD configuration. Thus, when user equipment is operated in the TDD configuration, the user equipment such as mobile communication devices are half duplex devices, which means they do not have the capability of transmitting and receiving wireless signals simultaneously.

In certain operating conditions, implementation of SBFD causes cross-link interference (CLI) such as adjacent channel CLI or co-channel interference to nearby neighboring networks. As further discussed below, FIG. 1 and FIG. 2 illustrate implementation of an SBFD communication configuration.

### BRIEF DESCRIPTION OF EXAMPLES

Techniques herein promote more efficient use of wireless resources by reducing wireless interference amongst multiple wireless stations communicating in a wireless network environment.

More specifically, the wireless system as discussed herein can be configured to a first wireless station (a.k.a., communication management resource). The first wireless station establishes wireless connectivity with multiple wireless stations including a second wireless station. The first wireless station transmits a first notification to the multiple wireless stations, where the first notification includes reference signal schedule information indicating a schedule for monitoring at least one reference signal. The first wireless station further transmits a second notification, where the second notification triggers the second wireless station to monitor the at least one reference signal as indicated by the reference signal schedule information.

In one example, the at least one reference signal includes a first wireless reference signal. The first wireless station transmits the first wireless reference signal to the second wireless station as indicated by the schedule.

In response to the first wireless station transmitting at least one reference signal, the first wireless station receives feedback from the second wireless station. The feedback indicates a magnitude of wireless interference associated with the second wireless station receiving at least one reference signal. The first wireless station compares the magnitude of wireless interference to a threshold level. In response to detecting that the magnitude of the wireless interference is greater than the threshold level, the first wireless station modifies wireless resources allocated to support a wireless connection between the first wireless station and the second wireless station.

Yet further, another example as discussed herein includes the first wireless station transmitting the second notification in response to detecting that a performance of a wireless communication link between the first wireless station and the second wireless station falls below a threshold level.

The first wireless station can be configured to determine the performance of the wireless communication link in any suitable manner. In one example, the first wireless station determines the performance of the wireless communication link between the first wireless station and the second wireless station based on feedback from the second wireless station indicating an inability of the second wireless station to receive wireless communications transmitted in a downlink direction from the first wireless station to the second wireless station.

In another example, the first wireless station determines the performance of the wireless communication link between the first wireless station and the second wireless station based on feedback from the second wireless station, where the feedback indicates a wireless power level at which the first wireless station receives wireless communications from the first wireless base station.

In still further examples, the reference signal schedule information can be configured to indicate a frequency and time that the first wireless station is scheduled to transmit a first wireless reference signal of at least one reference signal from the first wireless station.

Yet further, the reference signal schedule information can be configured to indicate an encoding configuration assigned to transmitting at least one reference signal.

Still further, at least one reference signal can be scheduled for transmission via at least one symbol scheduled for transmission from the first wireless station. The reference signal schedule information can be configured to indicate timing of transmitting at least one symbol in a timeslot.

In another example, the reference signal schedule information can be configured to indicate multiple different channels to be monitored by the second wireless station for detection of at least one reference signal. In response to transmitting the second notification, the first wireless station receives feedback from the second wireless station, where the feedback indicates different levels of wireless interference associated with the second wireless station receiving at least one reference signal in the multiple different channels. Further, in response to determining a first channel of the multiple different channels at which the second wireless station receives at least one reference signal below an interference threshold level, the first wireless station allocates the first channel to support a first wireless communication link between the first wireless station and the second wireless station.

According to further examples as discussed herein, the multiple wireless stations can be configured to include a third wireless station and a fourth wireless station; the reference signal schedule information can be configured to indicate a schedule for transmitting at least one reference signal from the fourth wireless station to the second wireless station. In one example, the first wireless station is a first wireless base station in a first wireless network; the second wireless station is a first mobile communication device wirelessly connected to the first wireless base station in the first wireless network; the third wireless station is a second wireless base station in a second wireless network; and the fourth wireless station is a second mobile communication device, the second mobile communication device wirelessly connected to the second wireless base station in the second wireless network.

Yet further, the second wireless base station can be configured to transmit the reference signal schedule information to the second mobile communication device; the transmission of the second notification prompts the second wireless base station to notify the second mobile communication device to transmit at least one reference signal from the second mobile communication device to the first mobile communication device in a manner as indicated by the reference signal schedule information. The first wireless base station receives feedback from the first mobile communication device, where the feedback indicates a magnitude of wireless interference associated with the first mobile communication device receiving at least one reference signal transmitted from the second mobile communication device.

In further examples, at least one reference signal is transmitted over a first wireless channel. In response to the first wireless base station detecting that the magnitude of the wireless interference is above a threshold level, the first wireless base station communicates with the second wireless base station to negotiate discontinued use of the first wireless channel by the second wireless base station.

Still further, at least one reference signal may be transmitted over a first wireless channel. In response to detecting that the magnitude of the wireless interference is above a threshold level, the first wireless base station can be configured to allocate use of a second wireless channel by the first mobile communication device as a substitute to the first wireless channel.

A further example, a first wireless base station implements a first time division duplex configuration to communicate with first mobile communication devices in a network environment. The first wireless base station receives notification of a second time division duplex configuration implemented by a second wireless base station to communicate with second mobile communication devices. The first wireless base station monitors wireless communications transmitted by the second wireless base station. Based on the monitoring, the first wireless base station implements a third time division duplex configuration as a substitute to implementing the first time division duplex configuration.

In one example, the first wireless base station measures wireless interference associated with receiving a wireless communication from the second wireless base station. Based on the monitoring, the first wireless base station modifies the first time division duplex configuration to produce the third time division duplex configuration.

Another example, the first wireless base station transmits notification of the third time division duplex configuration to the second wireless base station.

In still further examples, in accordance with the third time division duplex configuration, the first wireless base station communicates with the first mobile communication devices to schedule uplink communications from the first mobile communication device to the first wireless base station.

Note that any of the resources as discussed herein can include one or more computerized devices, communication management resources, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including computer readable storage hardware (such as hardware to store executable instructions), non-transitory computer-readable storage media, etc., on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage hardware medium or computer readable hardware such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed on a computerized device to cause the computerized device to perform the techniques explained herein.

Accordingly, examples herein are directed to a method, system, computer program product, etc., that supports operations as discussed herein.

One example as discussed herein includes computer readable storage hardware and/or system having instructions stored thereon to facilitate better use of available wireless resources. The instructions, when executed by computer processor hardware, cause the computer processor hardware (such as one or more co-located or disparately processor devices or hardware) to: at a first wireless station: establish wireless connectivity with multiple wireless stations including a second wireless station; transmit a first notification to the multiple wireless stations, the first notification including reference signal schedule information indicating a schedule for monitoring at least one reference signal; and transmit a second notification, the second notification triggering the second wireless station to monitor the at least one reference signal as indicated by the reference signal schedule information.

Another example as discussed herein includes a computer readable storage hardware and/or system having instructions stored thereon to facilitate better use of available wireless resources. The instructions, when executed by computer processor hardware, cause the computer processor hardware (such as one or more co-located or disparately processor devices or hardware) to: at a first wireless base station implementing a first time division duplex configuration to communicate with first mobile communication devices: receive notification of a second time division duplex configuration implemented by a second wireless base station to communicate with second mobile communication devices; monitor wireless communications transmitted by the second wireless base station; and based on the monitoring, implement a third time division duplex configuration as a substitute to implementing the first time division duplex configuration.

Note that the ordering of the steps above has been added for clarity sake. Further note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing wireless communication services. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a network environment and scheduling of so-called SBFD (Sub-Band Full Duplex) as discussed herein.

FIG. 2 is an example diagram illustrating simultaneous use of different portions of a frequency band to support simultaneous uplink and downlink wireless communications as discussed herein.

FIGS. 3A and 3B are example diagrams illustrating wireless interference resulting from wireless stations communicating in a respective wireless network environment based on non-coordinated wireless communications as discussed herein.

FIGS. 4A and 4B are example diagrams illustrating a first control configuration supporting cross-link interference measurements as discussed herein.

FIG. 5 is an example diagram illustrating encapsulation of control configuration information inside a so-called CSI-ResourceConfig as discussed herein.

FIG. 6 is an example diagram illustrating encapsulation of a second control configuration as discussed herein.

FIG. 7 is an example diagram illustrating a periodic wireless interference measurement triggers as discussed herein.

FIG. 8 is an example diagram illustrating semi-persistent wireless interference measurements as discussed herein.

FIG. 9 is an example diagram illustrating semi-persistent triggering of wireless interference measurements as discussed herein.

FIGS. 10A, 10B, 10C, and 10D, are example diagrams illustrating implementation of wireless interference measurements associated with a first configuration as discussed herein.

FIGS. 11 and 12 are example diagrams illustrating implementation of wireless interference measurements associated with a first configuration as discussed herein.

FIG. 13 is an example diagram illustrating a periodic wireless interference measurement triggering as discussed herein.

FIG. 14 is an example diagram illustrating activation and deactivation of wireless interference measurement configurations as discussed herein.

FIG. 15 is an example diagram illustrating an example modification enabling a neighbor wireless base station to request time division duplex configuration information as discussed herein.

FIGS. 16 and 17 are diagrams illustrating example of Xn and F1 slot configuration lists discussed herein.

FIG. 18 is an example diagram illustrating Xn interface message flow as discussed herein.

FIG. 19 is an example diagram illustrating resource status request information as discussed herein.

FIG. 20 is an example diagram illustrating resource status updated information as discussed herein.

FIG. 21 is an example diagram illustrating F1 message flow as discussed herein.

FIG. 22 is an example diagram illustrating resource status information as discussed herein.

FIG. 23 is an example diagram illustrating resource status update information as discussed herein.

FIG. 24 is an example diagram illustrating implementation of cross-link interference measurements and wireless interference mitigation techniques as discussed herein.

FIG. 25 is an example diagram illustrating uncoordinated UE to UE wireless interference mitigation as discussed herein.

FIG. 26 is an example diagram illustrating UE to UE wireless interference mitigation without a TDD configuration change and coordinated across neighbor wireless base stations as discussed herein.

FIG. 27 is an example diagram illustrating base station to base station wireless interference mitigation as discussed herein.

FIG. 28 is an example diagram illustrating diagram illustrating base station to base station wireless interference mitigation without a TDD configuration change and with coordination across neighboring wireless base stations with the unique reference signal as discussed herein.

FIG. 29 is an example diagram illustrating diagram illustrating base station to base station wireless interference mitigation without a specific cross-link interference-RS (Reference Signal) and without a TDD configuration change and with coordination across neighboring wireless base stations as discussed herein.

FIG. 30 is an example diagram illustrating Coordinated TDD-UL-DL Configuration change in flexible symbols as discussed herein.

FIG. 31 is an example diagram illustrating Coordinated TDD-UL-DL configuration guided by measurements via a requesting wireless base station as discussed herein.

FIG. 32 is an example diagram illustrating cross-link interference (i.e., UE-UE and/or gNB-gNB) interference mitigation (i) with TDD Configuration Change and (ii) with coordination across neighbor gNBs as discussed herein.

FIG. 33 is an example diagram illustrating example computer architecture operable to execute one or more operations as discussed herein.

FIG. 34 is an example diagram illustrating a method as discussed herein.

FIG. 35 is an example diagram illustrating a method as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

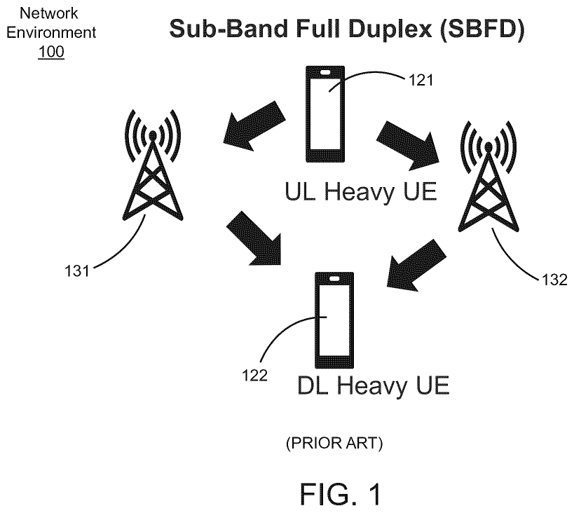

Now, more specifically, FIG. 1 is an example diagram illustrating a network environment and scheduling of so-called SBFD (a.k.a., Sub-Band Full Duplex) as discussed herein.

In this example, the network environment 100 includes wireless base station 131, wireless base station 132, . . . , mobile communication device 121 (a.k.a., user equipment), mobile communication device 122 (a.k.a., wireless station, user equipment, UE, etc.), etc.

Note that each of the wireless base stations in the network environment 100 is a wireless station supporting wireless communications with other wireless stations. Each wireless base station may be a gNB or other suitable entity supporting wireless communications in a network environment 100.

As further shown in FIG. 1, the network environment 100 can be configured to support so-called sub-band full duplex (SBFD) communications.

Further, via uplink wireless communications from the mobile communication device 121, the mobile communication device 121 is able to convey respective data in an uplink direction to either the wireless base station 131 and/or the wireless base station 132.

In a reverse direction, via downlink wireless communications from the wireless base station 131 and wireless base station 132, the mobile communication device 121 is able to receive respective data in a downlink direction from either the wireless base station 131 and/or the wireless base station 132.

Further, via uplink wireless communications from the mobile communication device 122, the mobile communication device 122 is able to convey respective data in an uplink direction to either the wireless base station 131 and/or the wireless base station 132. In a reverse direction, via downlink wireless communications from the wireless base station 131 and wireless base station 132, the mobile communication device 121 is able to receive respective data in a downlink direction from either the wireless base station 131 and/or the wireless base station 132.

As further discussed herein, simultaneous transmission of wireless communications from any of the wireless stations (wireless base station 131, wireless base station 132, . . . , mobile communication device 121, mobile communication device 122, . . . ) may result in undesirable wireless interference.

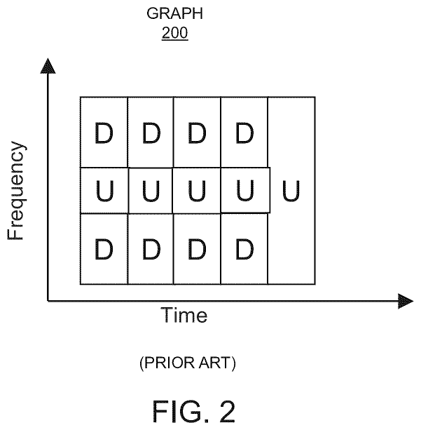

FIG. 2 is an example diagram illustrating simultaneous use of different portions of a frequency band to support both uplink and downlink communications as well as SBFD communications as discussed herein.

As shown in graph 200, implementation of sub-band frequency division communications includes support of simultaneous uplink and downlink communications in the same timeslot.

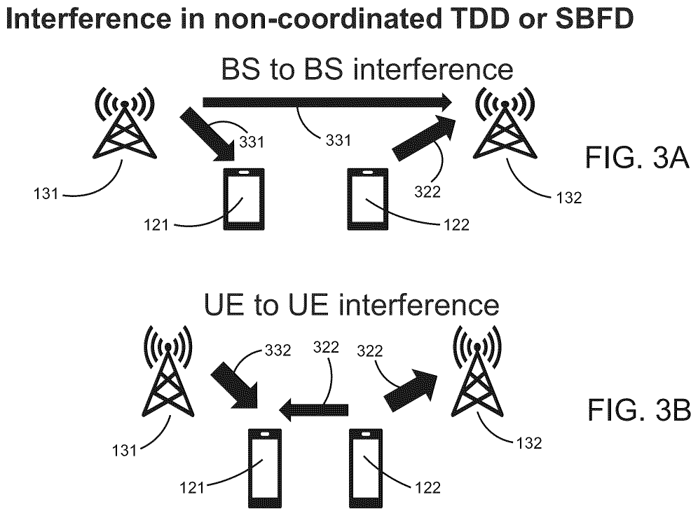

FIGS. 3A and 3B are example diagrams illustrating wireless interference resulting from wireless stations communicating in a respective wireless network environment based on non-coordinated communications as discussed herein.

More specifically, as shown in FIG. 3A, the wireless base station 131 transmits communications 331 in the downlink direction to the mobile communication device 121. At the same time, the mobile communication device 122 transmits wireless communications 322 in an uplink direction from the mobile communication device 122 to the wireless base station 132.

The wireless communications 331 may be transmitted in a same or different wireless channel than the wireless communications 322. The transmission of the wireless communications 331 interferes with the ability of the wireless base station 132 to receive the wireless communications 322. Thus, FIG. 3A, illustrates base station to base station interference.

In a different scenario, as shown in FIG. 3B, the wireless base station 131 transmits communications 332 in the downlink direction to the mobile communication device 121. At the same time, the mobile communication device 122 transmits wireless communications 322 in an uplink direction from the mobile communication device 122 to the wireless base station 132. The wireless communications 332 may be transmitted in a same or different wireless channel than the wireless communications 322. The simultaneous transmission of the wireless communications 322 with communications 332 interferes with the ability of the mobile communication device 121 to receive the wireless communications 332 from the wireless base station 131. Thus, FIG. 3B, illustrates user equipment to user equipment wireless interference.

This disclosure includes the observation that wireless interference may occur in a single operator network whose gNBs (a.k.a., wireless a station) use coordinated TDD (Time Division Duplex) communication configurations as a baseline to manage conveyance of wireless communications in the network environment. For example, in certain instances, a network operator may deploy SBFD, resulting in only in their DL/flexible symbols/slots giving rise to co-channel CLI in the network.

It is further observed that:
i) An SBFD-supporting gNB (a.k.a., wireless base station) may cause UE-to-UE interference to cell edge UEs (User Equipment) of a neighboring gNB or network using legacy TDD communication configurations.
ii) A gNB using legacy TDD configurations may cause gNB-to-gNB interference to a neighbor gNB in network that supports SBFD during its UL (Uplink) transmissions in DL (Downlink) time slots.

If there are two or more different network operators in the network environment 100, and corresponding different wireless networks, and one of wireless networks associated with a first network operator employs SBFD in its network, then this may cause the following wireless interference in the respective networks:
i) If the two wireless network operators are not using coordinated TDD communication configurations, then both wireless networks from different network operators may suffer from severe gNB-to-gNB wireless interferences.
ii) If the two wireless network operators are using coordinated TDD configurations:
   a) The SBFD-supporting network associated with the first wireless network operator may suffer from gNB-to-gNB interferences from the neighbor legacy TDD network (i.e., wireless network that does not support SBFD communications) associated with the second wireless network operator during UL transmissions in the DL slots.
   b) The legacy TDD network may suffer from cell edge UE-to-UE interferences from the neighbor SBFD supporting network.

In the context of co-existence operations and within the confines of a given (e.g., conventional) TDD configuration, techniques herein include implementing cross-link interference measurements by a wireless station such as a gNB (i.e., prior to changing a TDD configuration) to mitigate both co-channel and adjacent channel interference (e.g., as input to scheduler and resource allocator).
i) Conventional communication specifications rely on CSI-IM or ZP-CSI-RS for wireless interference measurements. However, these conventional communication implementations do not seamlessly handle CLI measurements in the context of conventional communication operations.

This disclosure further includes the observation that it is useful to implement wireless signal interference measurements that can be used to ensure minimum Cross Link Interference (CLI) between neighboring cells and respected communicating wireless stations in a network environment 100. For example, it is beneficial to implement reference signals in parallel to current definitions of CSI-IM and ZP CSI-RS that is simple and requires less control signaling.

In a further example, it is noted that, if a gNB dynamically changes its TDD configuration (e.g., from DL/flexible symbols/slots configuration to a SBFD configuration or DL or UL configuration) without considering its neighbor gNB's TDD configuration, this may result in severe cross-link interference amongst the networks. This disclosure further includes the observation that, prior to switching over to a different TDD configuration, it may be desirable to consider the neighboring gNBs TDD configuration before making changes. As further discussed herein, consideration of neighbor TDD configurations may include one or more gNBs requesting TDD configurations implemented by neighboring gNBs such as via any suitable communication interface (Xn interface, F1 interface, etc.).

Yet further, operations herein provide an alternate one or more techniques to coordinate the TDD configurations and SBFD configurations across different networks such that all networks are protected from the co-channel cross-link interference as well as adjacent channel interference (such as if Xn interface exists between two different operators). Further, as discussed herein, it is desirable that network management can be configured to manage symbol level granularity to cover signaling of SBFD operation indicating the sub-bands allocated as DL or UL.

### Cross-Link Interference (CLI) Reference Signal (RS) Configuration

As previously discussed, implementation of a SBFD configuration by a wireless network and corresponding wireless stations allows full duplex services in all the DL or flexible symbols/slots. SBFD symbols/slots allocate certain bandwidth for UL while the remaining bandwidth will be reserved for DL, where the uplink and downlink reserved timeslots or symbols support simultaneous communications between a first wireless station and a second wireless station.

In accordance with one standard, bandwidth allocation for DL may be in non-contiguous frequency sub-bands while UL bandwidth is contiguous. It is foreseeable that another standard allows UL bandwidth to be non-contiguous.

The DL and/or flexible symbols/slots in a respective TDD configuration that are potentially convertible to SBFD symbols/slots may not be contiguous to each other.

It is desirable that implementation of multiple reference signals (RS) to monitor cross-link interference are flexible enough to measure CLI (UE-to-UE and gNB-to-gNB) that may be introduced by SBFD in different bands and should be less complex in signaling to nodes (connected UEs or neighboring gNBs).

In one example, a new reference signal implementation (such as including implementation of reference signal schedule information) includes allocation of an array/sequence of sub-regions (in time and/or in frequency), with each sub-region being defined such that the triggered wireless station either transmits one or more reference signals or receives one or more reference signals in a particular time slot.

In other words, examples herein include implementing reference signal schedule information or wireless test configuration implemented by one or more wireless stations to determine different levels of wireless interference in the network environment. In accordance with the reference signals schedule information (a.k.a., wireless test configuration or wireless interference test configuration), one or more wireless stations transmit one or more reference signals at a time and/or frequency as specified by the reference signal schedule information. Further, in accordance with the reference signal schedule information, one or more wireless stations receive the one or more transmitted reference signals at the time and/or frequency as specified by the reference signal schedule information. The receiving wireless stations produce wireless interference information (feedback) indicating an amount of wireless interference associated with receiving the one or more transmitted reference signals.

As further discussed herein, a communication management resource (such as associated with a wireless base station or a wireless network) uses the detected wireless interference information as collected during the wireless interference test configuration a basis to mitigate occurrence of subsequent wireless interference in the network environment.

The reference signal implementation and corresponding reference signal schedule information and testing as discussed herein can be configured to support one or more of:
Flexible time signaling
   timeslot information indicating when to transmit/monitor a reference signal for wireless interference testing
   Starting symbol (counted from the beginning of a frame or time slot) for transmitting or receiving wireless reference signals
   #of consecutive symbols in a respective time slot for transmitting or receiving a one or more wireless reference signals
Flexible frequency signaling
   Starting resource block indicating when to transmit or receive wireless reference signals
   #of consecutive resource blocks to be used for transmitting or receiving wireless reference signals
   Starting RE(s) (resource element(s)), within resource block to be used for transmitting or receiving wireless reference signals
   #of REs within resource block for transmitting or receiving wireless reference signals
   ‘Comb pattern’ of REs, which defines the stride between two consecutive REs allocated for CLI measurement for transmitting or receiving reference signals

Note further that any or all frequency resources identified by the above testing may be muted (i.e., not used by the scheduler). In other words, during cross-link interference testing, in accordance with the wireless reference signal transmission and monitoring, when one or more first wireless stations are scheduled to transmit one or more reference signals while one or more second wireless stations are scheduled to receive those transmitted reference signals, the communication management resource or other suitable entity as discussed herein can be configured to prevent use of certain wireless resources (such as bandwidth, channels, etc.) by any of the wireless stations in the network environment 100 so that those muted wireless stations do not interfere with the cross-link interference testing supported by the wireless stations implementing the reference signal schedule information (a.k.a., cross-link interference-reference signal test configuration) as discussed herein.

After all the involved nodes (wireless stations in the network environment) are (made) aware of these CLI measurement resources as indicated by reference signals schedule information, the respective wireless interference measurements as indicated by the reference signal schedule information can be implemented in any suitable manner. In one example, the wireless interference measurements associated with the reference signal schedule information support:
A) for gNB to UE circumstances:
   Aperiodically, in which case measurements are triggered by gNB using DCI (Downlink Control Information)—a Layer 1 (PHY) specific signaling
   Semi-persistently, in which case they are repeated on a periodic basis, triggered by gNB using existing mechanism of a MAC-CE (MAC control element)—a Layer 2 (MAC) specific signaling
   Periodically, in which case measurements are configured by RRC—a Layer 3 specific signaling—and repeated periodically, indefinitely until the configuration is replaced by another configuration
   For both semi-persistent and periodic cases, the period may be a multiple of the frame durations
B) for gNB to gNB circumstances:
   Same principle of triggering aperiodic, semi-persistent or periodic CLI measurement is applicable but trigger may be through an Xn interface
   Over The Air (OTA) interface triggering may also be used and will have following requirements
      Non-Zero Power (NZP) Reference Signal (RS) that will uniquely identify the coordination-requesting gNB; e.g., using Zadoff-Chu sequence as a base sequence to tell neighboring gNBs of the request
      A cell specific unique sequence or cell ID may be used to scramble the data that will be transmitted along with the NZP RS. Receiving gNBs will do blind decoding based on known Cell IDs or unique signatures to identify the coordination-requesting gNB
      Data field will contain the information about time and frequency resources as defined above as well as cell ID of neighboring gNB to indicate, which of the neighboring gNB's cell needs to help in coordinated CLI measurements
      Since coordination-requesting gNB knows the TDD Configuration of neighboring cells, it will transmit the NZP-RS during the flexible symbols/slots of the neighboring gNBs to indicate coordination request for CLI

To limit specification changes and re-use the current mechanisms of DCI (a.k.a., Downlink Control Information) and MAC-CE (Media Access Control-Control Element) with minimal changes, exemplary new reference signals are defined in the context of the existing precedent set by CSI-IM (Channel State Information-Interference Measurement), ZP CSI-RS (Zero Power Channel State Information-Reference Signal) and RIM-RS (Remote Interference Measurement-Reference Signal).

To clearly detect whether interfering nodes were caused by wireless stations (UEs or gNBs) of one or more neighboring networks, a new NZP-RS as discussed herein implements novel reference signal transmission and measurements to perform wireless interference analysis. In one example, this RS (Reference Signal) may be referred to as IM-RS-r19 with the following requirements that differ from conventional RIM-RS specifications. In other words, conventional techniques can be modified to support the novel wireless interference analysis as discussed herein.

IM-RS-r19 will be defined with two exemplary configurations:
CONFIGURATION 1: Coordination request RS-RS sequence is generated using a Zadoff-Chu sequence with a base sequence
CONFIGURATION 2: Response CLI-RS-RS sequence is generated using Zadoff-Chu sequence with same base sequence as configuration 1 RS (Reference Signal) is, but with a different cyclic shift.

In accordance with further examples, a data field populated with data can be transmitted along with Configuration 1, which may be scrambled with the cell-ID or some other (preferably cell specific) unique signature. The data field indicating the reference signal schedule information can be configured to include information about time and frequency resources that are to be used to support the control of one or more wireless stations transmitting reference signals and one or more wireless stations receiving reference signals.

In a further example, the receiving gNBs can be configured to blindly decode the data filed with known cell IDs or unique signatures of neighboring gNBs to identify the coordination-requesting gNB. The data fields populated to support the reference signal schedule information can be configured to include any of one or more of the following information:
Start Time—when IM-RS-r19 CONFIGURATION 2 transmission starts
Stop Time—when IM-RS-r19 CONFIGURATION 2 transmission ends
Type of measurement—Aperiodic, semi-persistent, periodic
Cell ID(s) of neighboring gNB(s) to indicate, which of the neighboring gNB's cell(s) contribute to coordinating CLI measurements amongst the multiple wireless stations.
Multiplexing type—Time (to indicate time multiplexing, in which case time for each gNB will be indicated) or Code (if all neighbor gNB use same IM-RS-r19 CONFIGURATION 2 then a unique code is provided or cell id of the neighboring gNB is used to ‘spread’ IM-RS-r19).

If periodic measurement, then a field is to indicate stop coordination in order to terminate execution of the reference signal schedule information and wireless interference test analysis as discussed herein.

Triggering of CLI measurement using over the air interface may use the following exemplary procedure.

Coordination-requesting gNB (gNB1) will have information about the neighbor cell(s) TDD configuration pattern. Using the information about TDD configuration, gNB1 will transmit the IM-RS-r19 CONFIGURATION 1 during the flexible symbols/slots of the neighboring cell (e.g., gNB2).

If over the air interface is used to convey the resources to neighboring gNBs, then a data field as described above can be transmitted along with IM-RS-r19 CONFIGURATION 1. A gNB2 receiving CONFIGURATION 1 (first reference signal schedule information) can be configured to blindly decode the data field by despreading it with cell IDs or cell specific unique signatures. This will identify the coordination-requesting gNB1 sending the CONFIGURATION 1 information.

As further discussed herein, upon reception of the IM-RS-r19 CONFIGURATION 1, gNB2 will transmit IM-RS-r19 CONFIGURATION 2 on the indicated time/frequency resources for the duration that is specified by start/stop times according to measurement and multiplexing type.

Triggering of transmit/receive coordination information along with time, frequency and type of measurement may also be requested using Xn interface, which will transfer the data filed as defined above (without scrambling) indicating (the) resources for IM-RS-r19 Configuration 2 to neighboring gNBs.

In this case, IM-RS-r19 CONFIGURATION 1 is transmitted without data field, the responding-gNB will respond with IM-RS-r19 CONFIGURATION 2 (i.e., Reference signal measurements).

To stop coordination amongst the wireless stations and testing of wireless interference as discussed herein using reference signal scheduling information, IM-RS-r19 CONFIGURATION 1 signal will be retransmitted during the flexible symbols/slots of the neighbor cell TDD configuration with the stop field true. This notifies the receiving wireless stations to discontinue the wireless interference testing.

### Exemplary SBFD CSI-IM Resource Configuration-1

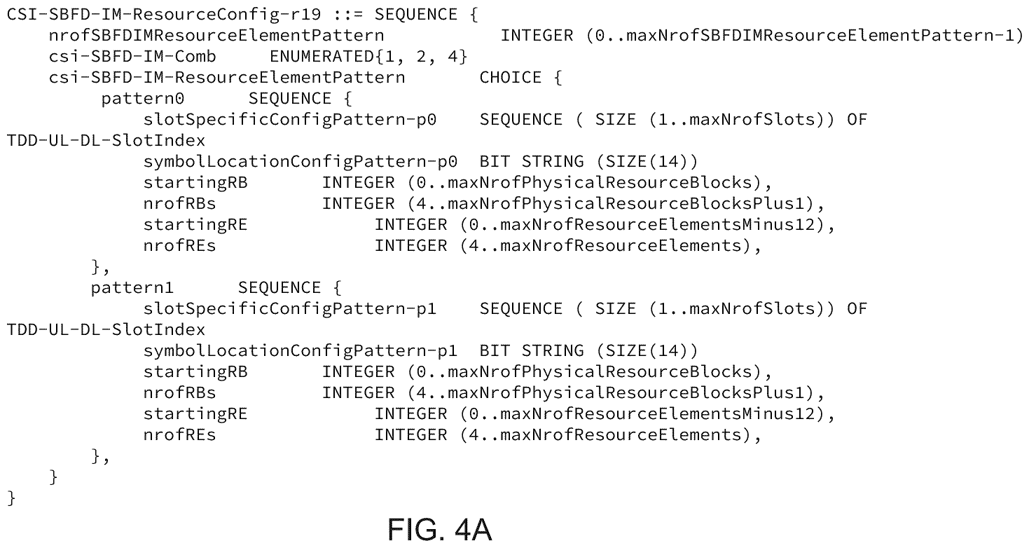

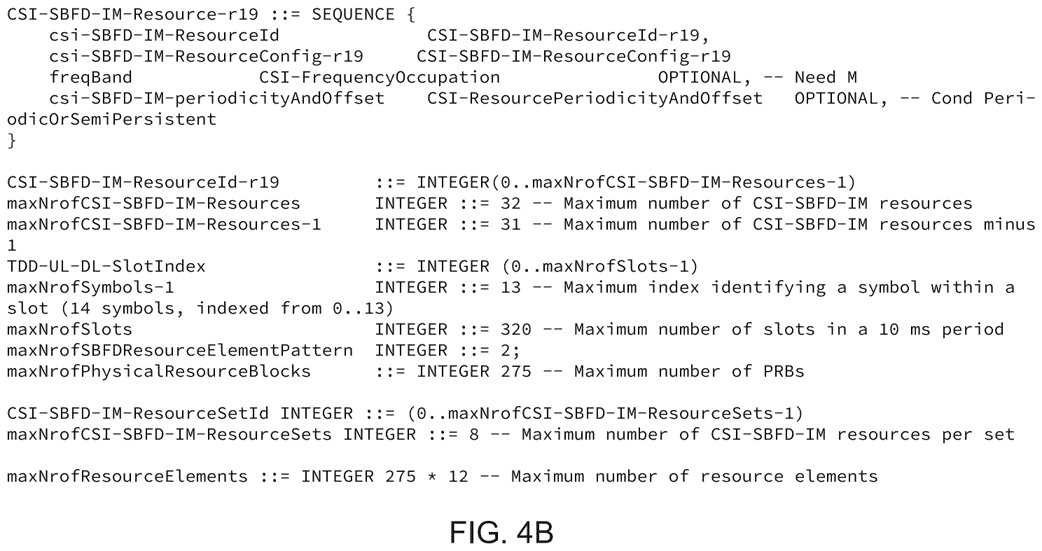

FIGS. 4A and 4B are example diagrams illustrating a first control configuration supporting cross-link interference measurements as discussed herein.

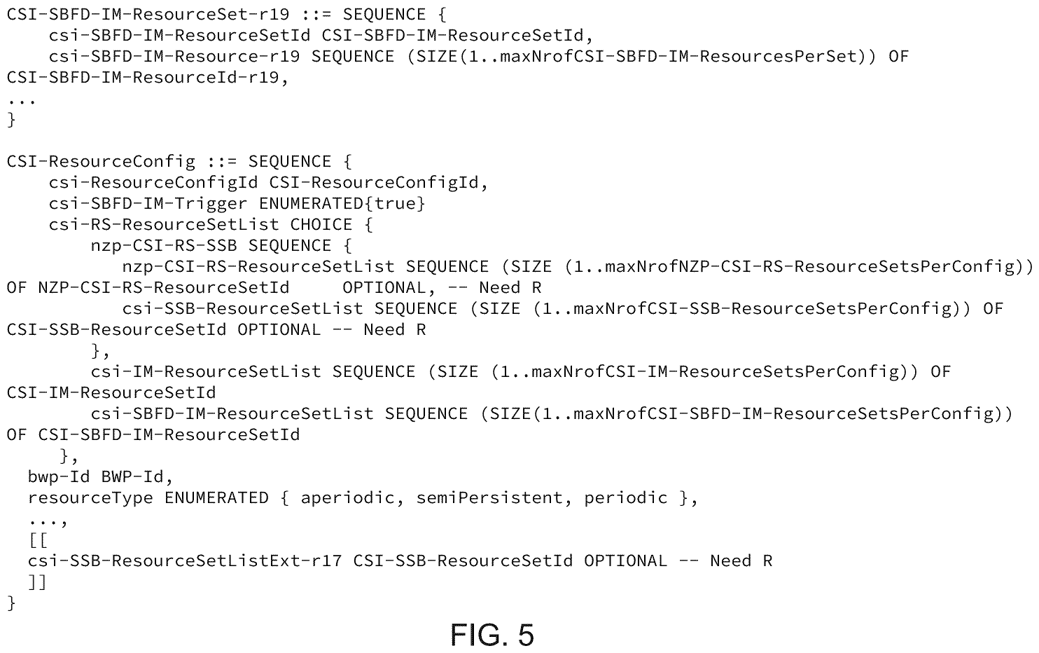

FIG. 5 is an example diagram illustrating encapsulation of control configuration information inside a so-called CSI-ResourceConfig as discussed herein.

As shown in FIGS. 4A, 4B, and 5, to perform cross-link interference measurements in accordance with the reference signal schedule information, a new SBFD-specific CSI-IM resource configuration is defined.

The new resource configuration mapping IE CSI-SBFD-IM-Resource-r19 is designed for a node (gNB or UE) to perform CLI measurements. The receiving wireless stations (gNB or UE) that are included in the wireless interference testing and that are configured with this CSI-IM resources subsequently perform sub-band interference measurements using the frequency- and time-domain resources specified in the reference signal scheduling information.

As shown and described in FIG. 5, the set of CSI-SBFD-IM-ResourceId-r19 may be encapsulated inside CSI-ResourceConfig.

### Exemplary SBFD CSI-IM Resource Configuration 2

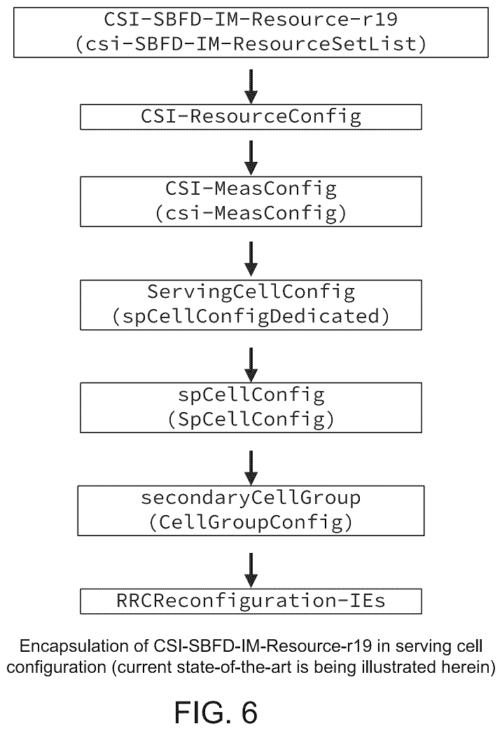

FIG. 6 is an example flow diagram illustrating encapsulation of a second control CONFIGURATION 2 as discussed herein.

In one example, this new CSI-RS configuration CSI-SBFD-IM-Resource-r19 is signaled (transmitting) to the UEs via RRCReconfiguration and FIG. 6 depicts the IE encapsulation hierarchy where the RRCReconfiguration-IEs is the top-level IE used for signaling RRCReconfiguration message.

As shown in FIG. 6, CSI-SBFD-IM-Resource-r19 is first encapsulated in a CSI-IM resource set csi-SBFD-IM-ResourceSetList, which is further encapsulated inside CSI-ResourceConfig.

CSI-ResourceConfig is placed inside CSI-MeasConfig and finally gets configured inside CellGroupConfig via ServingCellConfig and SpCellConfig in the order/dependencies shown in FIG. 6.

Upon receiving the RRCReconfiguration message (RRCReconfiguration-IEs)

If csi-SBFD-IM-Trigger flag in CSI-ResourceConfig is true, SBFD-capable UEs (Release-19) shall apply specific configuration sets in csi-SBFD-IM-ResourceSetList for the purpose of performing interference measurement.

The specific configuration sets, to be used for measurement, shall be signaled to the UE via RRC reconfiguration.

If csi-SBFD-IM-Trigger is not set, UEs shall ignore this field or network deployment shall not configure csi-SBFD-IM-ResourceSetList.

### Exemplary SBFD CSI-IM Signaling: Aperiodic

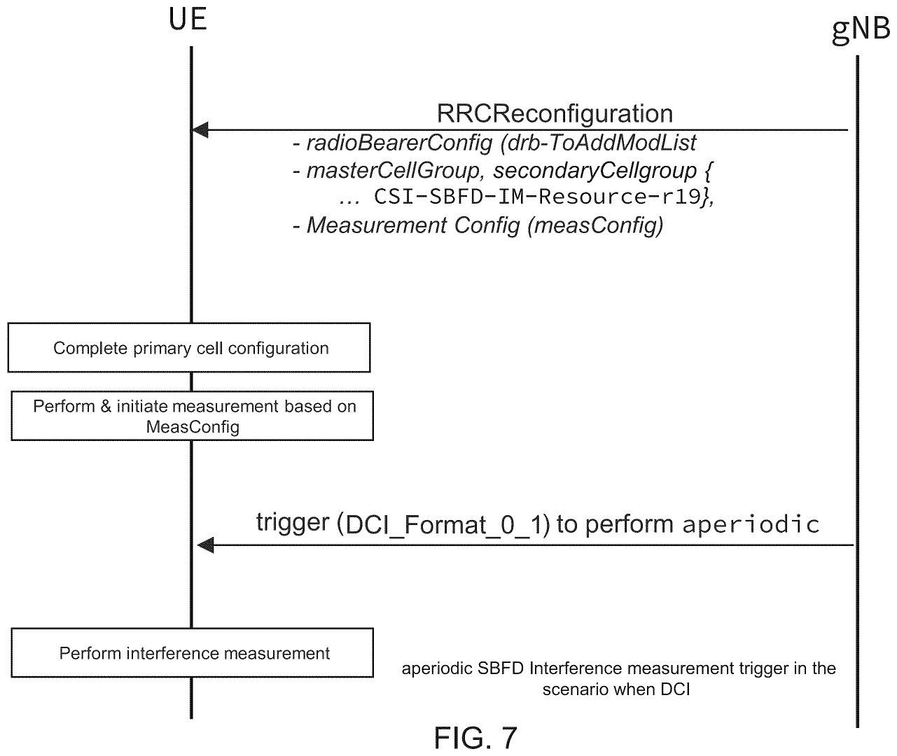

FIG. 7 is an example flow diagram illustrating a periodic wireless interference measurement triggers as discussed herein.

This example includes a signaling mechanism for each resource type. Resource type is defined by the resourceType in CSI-ResourceConfig-values may be aperiodic, semiPersistent, periodic, etc.

If no periodicity is configured, a respecting receiving UE as shown in FIG. 7 uses the aperiodic configuration and will be informed, such as via DCI (Downlink Control Indicator), to perform sub-band interference measurements as discussed herein.

If resource Type=aperiodic,

Upon reception of the DCI Format 0_1, the receiving UE maps of the codepoint in the ‘CSI Request’ field (6 bits) of DCI Format 0_1 to a corresponding Aperiodic Trigger State configured within the aperiodicTriggerStateList

Similarly, in the scenario between two gNBs, both the configuration and the trigger would rely on any suitable communication interface such as Xn interface, etc.

### Exemplary SBFD CSI-IM Signaling: Semi-Persistent

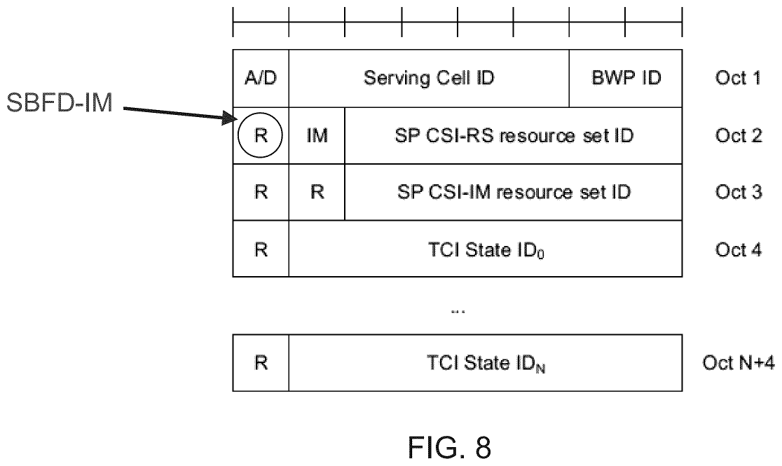

FIG. 8 is an example diagram illustrating semi-persistent wireless interference measurements as discussed herein.

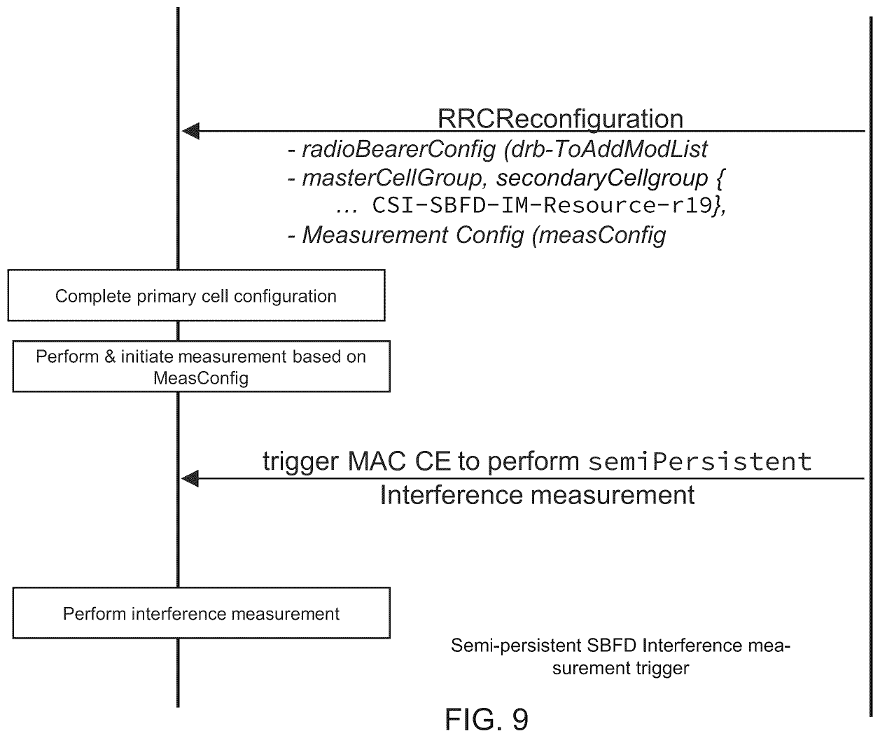

FIG. 9 is an example flow chart diagram illustrating semi-persistent triggering of wireless interference measurements by respective user equipment as discussed herein.

If resourceType=semipersistent

Replace one of the reserved bits “R” to indicate that this CSI-IM measurement is for SBFD. In the existing SP CSI-RS/CSI-IM MAC CE (TS 38.321, Section 6.1.3.12), a new bit flag (SBFD-IM) is added in bit-7 of Octet 2 as shown in FIGS. 8 and 9.

If SBFD-IM bit in Octet 2 is set to 1, perform SBFD interference measurement using resource set ID indicated by the “SP CSI-IM resource set ID” in the MAC CE.

Similarly, in the scenario between two gNBs both the configuration and the trigger would use the Xn interface (in one example).

Similarly, in the scenario between two gNBs both the configuration and the trigger would use the Xn interface (in one example).

### Exemplary SBFD ZP CSI-RS Configuration-1

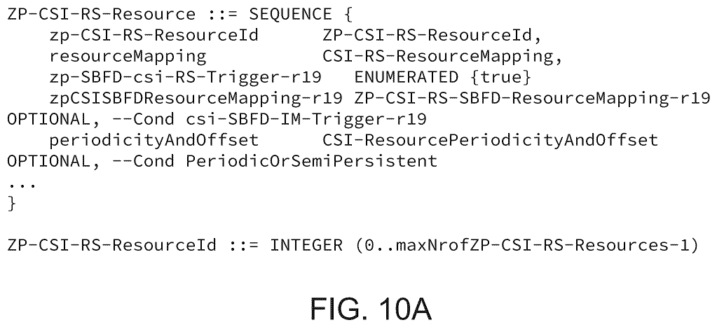

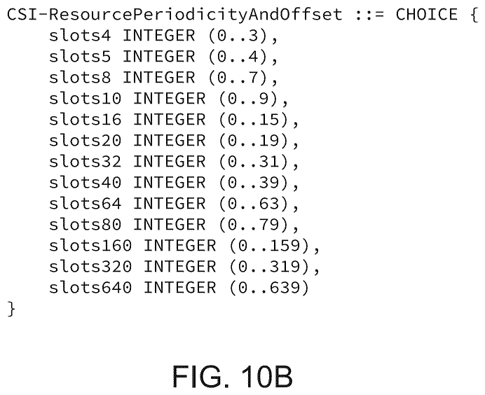

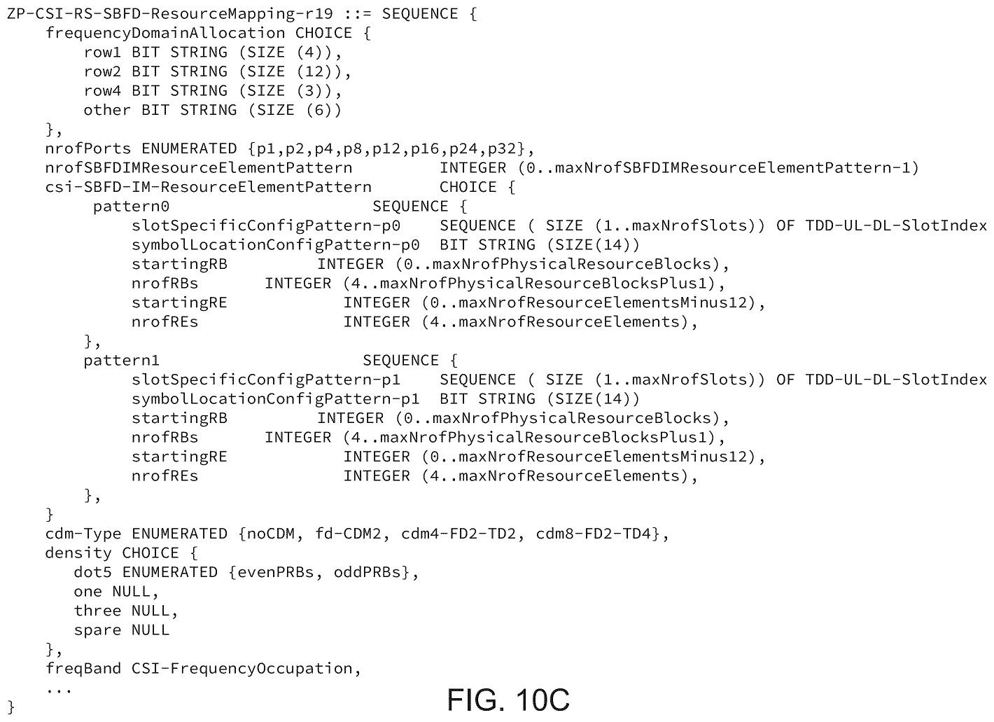

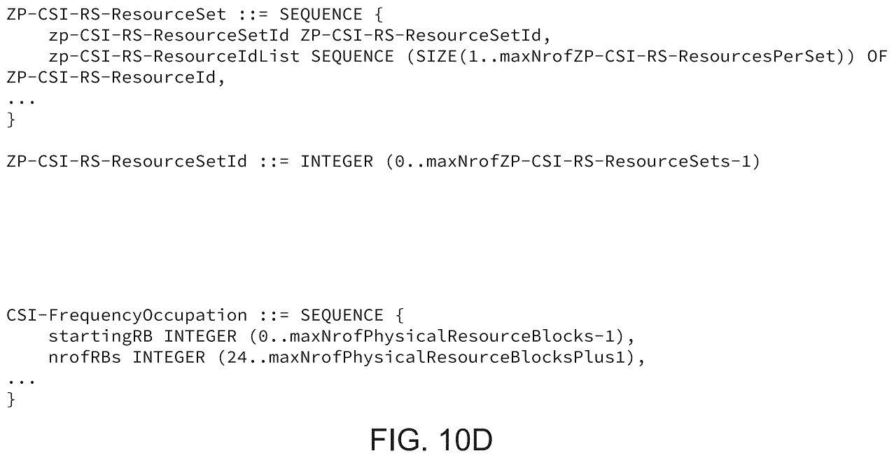

FIGS. 10A, 10B, 10C, and 10D, are example diagrams illustrating implementation (CONFIGURATION 1) of wireless interference measurements associated with a first configuration as discussed herein.

Note that other CSI-RS resources that could be used to perform UE-to-UE interference measurement within a gNB is the ZP CSI-RS as previously discussed.

To utilize the ZP CSI-RS for measurement within a gNB, a new SBFD specific ZP CSI-RS resource configuration is implemented.

Further, a new SBFD CLI measurement resource mapping (ZP-CSI-RS-SBFD-ResourceMapping-r19) is designed to enhance the existing ZP CSI RS (ZP-CSI-RS-Resource) for Release-19 UEs with SBFD capability.

### Exemplary SBFD ZP CSI-RS Configuration-2

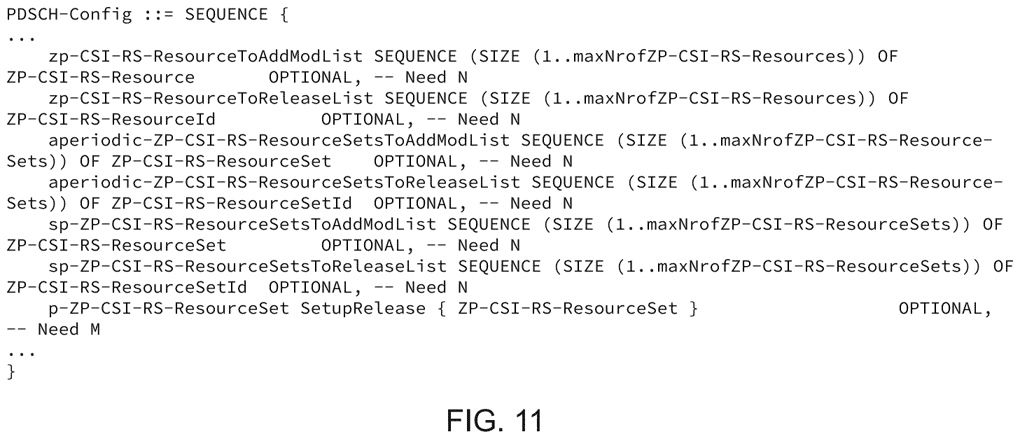

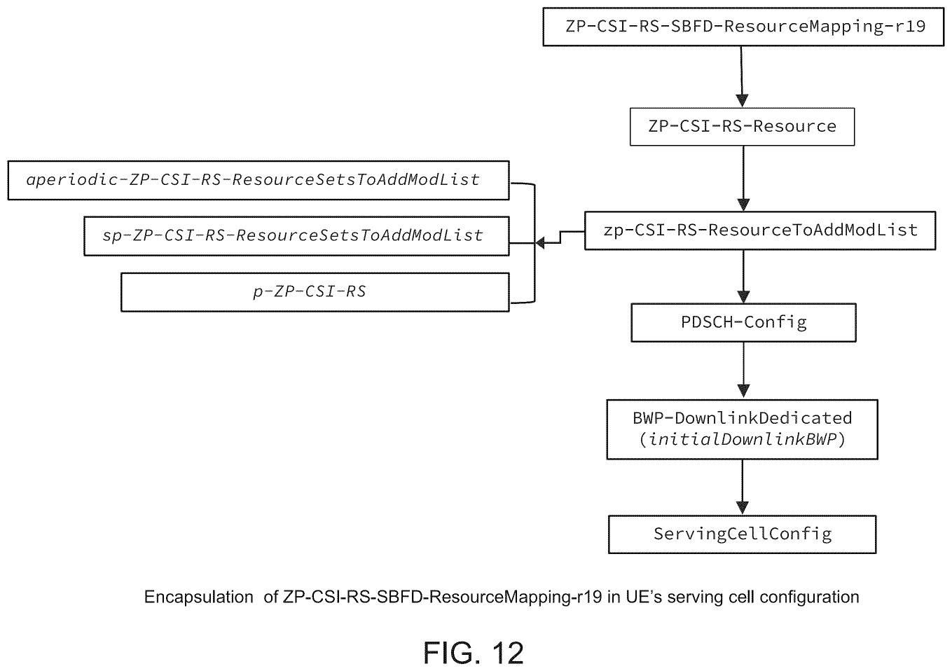

FIGS. 11 and 12 are example diagrams illustrating implementation of wireless interference measurements associated with a first configuration as discussed herein.

The following method is used to signal this ZP-CSI-RS-SBFD-ResourceMapping-r19 from gNB to UE.

This resource CONFIGURATION 2 can be encapsulated in ZP-CSI-RS-Resource and signaled to the UE via PDSCH-Config, which is carried by BWP-DownlinkDedicated as depicted in FIG. 11. FIG. 12 shows the sequence of encapsulating this new resource mapping IE in ServingCellConfig 1E, which is signaled through existing RRCReconfiguration message.

If desired, UEs configured in accordance with Release-19 UEs can be configured with based on the flag the zp-SBFD-csi-RS-Trigger-r19.

If this trigger flag is not set to true, the respective UE can ignore configuring or perhaps network configuration should ignore ZP-CSI-RS-SBFD-ResourceMapping-r19 in field in ZP-CSI-RS-Resource.

If this trigger flag is set, then UE with Release-19 SBFD capability will configure sub-band interference measurement using the resource mapping in ZP-CSI-RS-SBFD-ResourceMapping-r19 stored in ZP-CSI-RS-Resource as signaled by the gNB.

### Exemplary SBFD ZP CSI-RS Signaling-Aperiodic

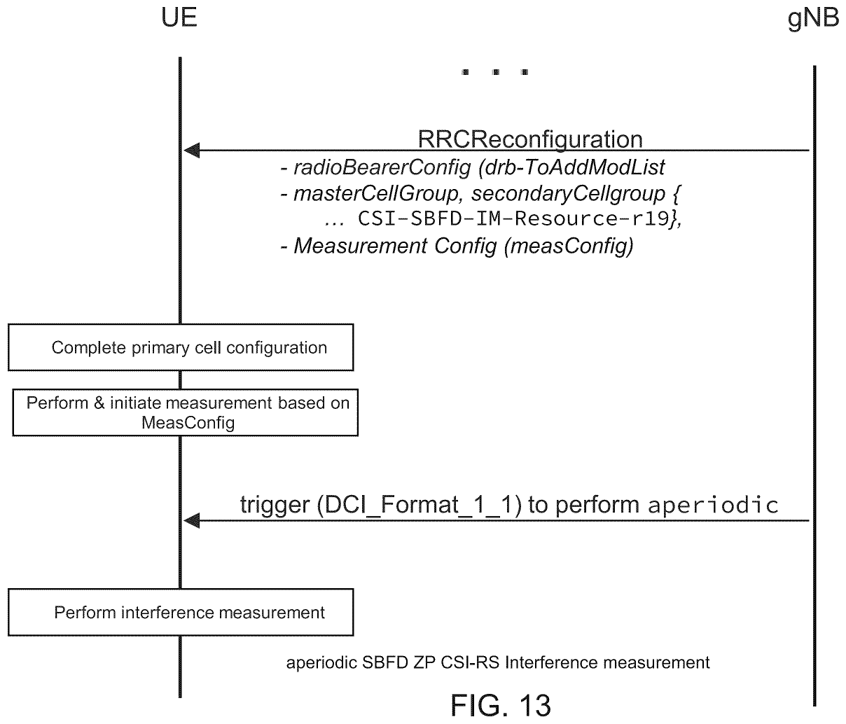

FIG. 13 is an example diagram illustrating periodic wireless interference measurement triggering to support wireless interference analysis as discussed herein.

As shown, If resource Type=aperiodic, then the “ZP CSI-RS Trigger” field in DCI Format 1_1 is used to trigger aperiodic Resource Set for measurement-currently it addresses upto 3 Resource Sets used for aperiodic measurement.

If desired, it is possible to expand the 3 resource sets to include the resource set for SBFD measurement or indicate that via the flag in zp-SBFD-csi-RS-Trigger-r19.

### Exemplary SBFD ZP CSI-RS Signaling-Semipersistent

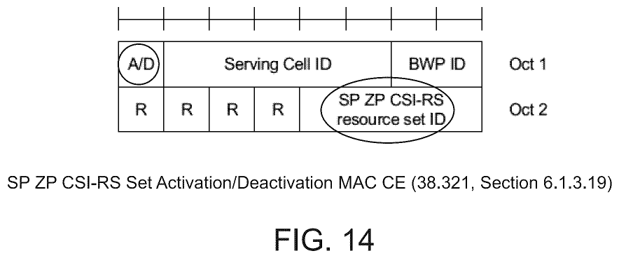

FIG. 14 is an example diagram illustrating activation and deactivation of wireless interference measurement configurations as discussed herein.

If resourceType=semipersistent, then:
If A/D is set to 1, activate the ZP CSI-RS resource set ID in SP ZP CSI-RS resource set ID.
   This resource set ID signaled in the MAC CE shall correspond to the SBFD measurement ZP CSI-RS.

### XN Interface Implementation/Requirements

As previously discussed, since SBFD will cause co-channel as well as adjacent channel Cross Link Interference (CLI), there may be a need to coordinate TDD-UL-DL-Configuration changes and CLI measurement campaigns with the neighboring gNBs.

If Xn interface exists between the neighboring gNBs, it may be desirable to implement the following changes to the XN interface. One or more the following operations can be implemented to support the wireless interference measurements as discussed herein:
Add a mechanism of requesting an exchange of latest TDD-UL-DL configurations from the neighboring gNBs. This will help the gNBs to analyze if the change in their TDD-UL-DL-Configuration might cause CLI in their neighboring networks
Enhance the TDD-DL-UL configuration exchange between the gNBs to include SBFD allocations
Enhance the interface to coordinate CLI measurements
   All the CLI-RS resources (time, frequency etc) are conveyed to neighboring cells to coordinate the CLI measurements
   A trigger to start the measurements
   Transfer of measurement reports. For example, reports can be configured to indicate will indicate CLI being introduced by the aggressive gNB. Reports may contain power level, delta of CLI power levels measured with respect to last TDD configuration of aggressive cell.

### Exemplary Modification for Neighbor GNB to Request Tdd DL-UL Configuration

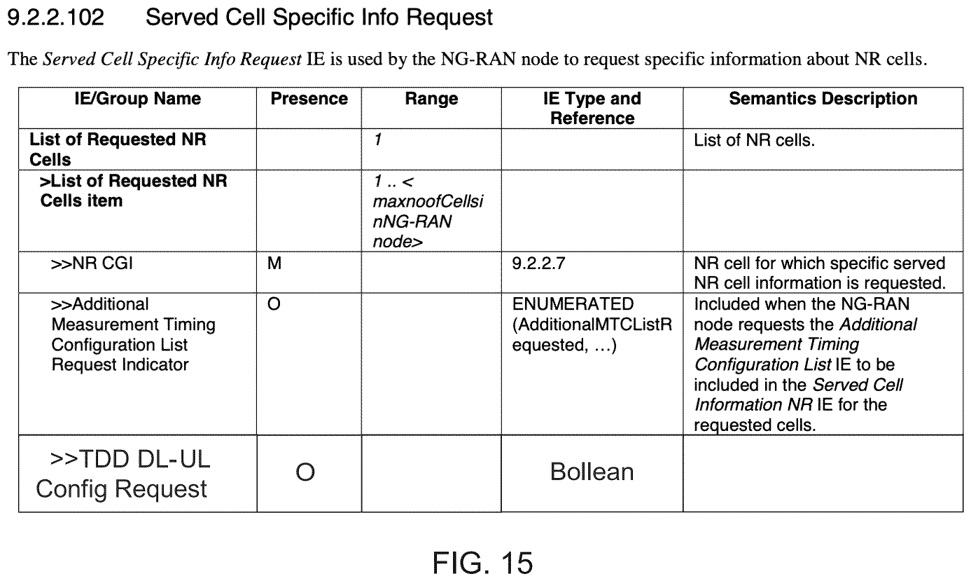

FIG. 15 is an example diagram illustrating an example modification enabling a neighbor wireless base station to request time division duplex configuration information as discussed herein.

Examples herein include the following messages:
NG-RAN NODE CONFIGURATION UPDATE
In the IE “Served Cell Specific Info Request”
   Add IE “TDD DL-UL Config Request”

In terms of procedure:

Upon receiving a NG-RAN NODE CONFIGURATION UPDATE message including the “Served Cell Specific Info Request” IE indicating the request for “TDD DL-UL Config Request”, the receiving gNB responds with a response message including a NG-RAN NODE CONFIGURATION UPDATE ACKNOWLEDGE message, where the response message includes the IE “Served Cell Information NR”, which may be coded with just the essential mandatory IE, plus the TDD UL-DL

### Exemplary XN AND F1 “Slot Configuration List-Alternative 1”

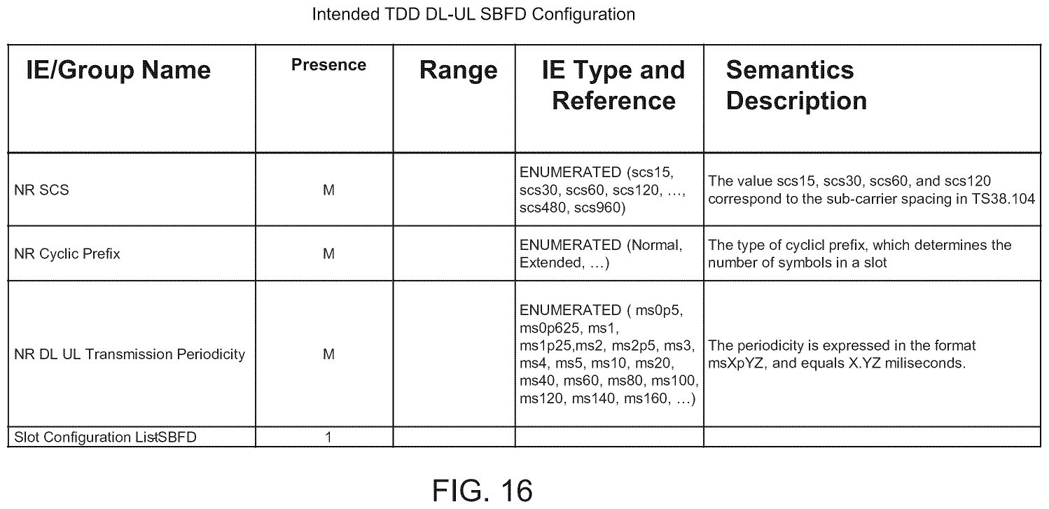

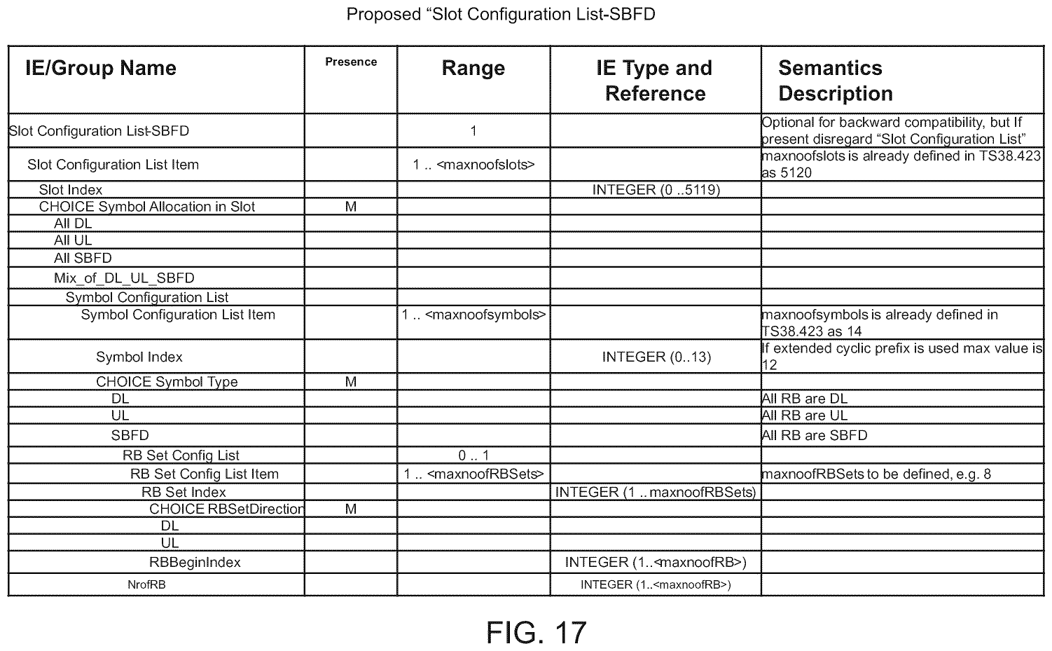

FIGS. 16 and 17 are diagrams illustrating example of Xn and F1 slot configuration lists discussed herein.

Exemplary IE (Information Element) as shown may be useful to transfer Intended TDD DL-UL SBFD configuration between gNBs using Xn interface.

A new Information Element (IE) may be added in the Xn interface “Intended TDD DL-UL SBFD Configuration”

A flag “Slot Configuration List-SBFD” if true in this IE will indicate to the receiving gNB to read the TDD-UL-DL-Configuration for changes to DL/UL/SBFD symbol/slot patterns

A new IE “Slot Configuration List-SBFD” may be defined that defines the DL, UL, SBFD symbols and PRB Allocation for SBFD symbols

For F1 interface:
Currently F1 definition of “Intended TDD DL-UL Configuration” is the same definition as in RRC. F1 can be configured to use the same generalized definition of “Intended TDD DL-UL Configuration” as used by RRC.

### Exemplary XN Modifications to Resource Status Request and Resource Status Update to Support Coordinated CLI Measurements

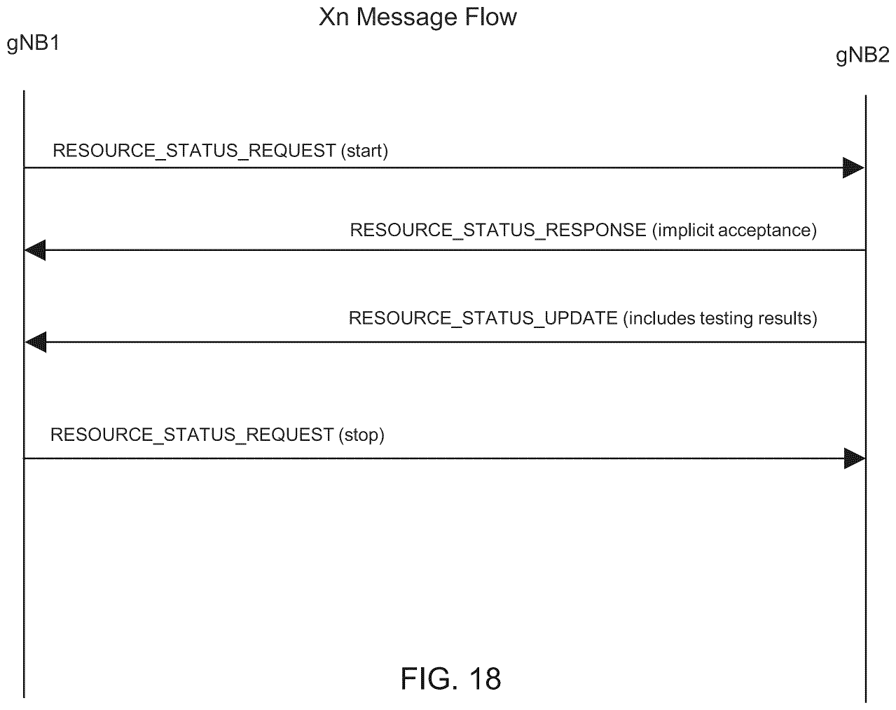

FIG. 18 is an example diagram illustrating Xn message flow as discussed herein.

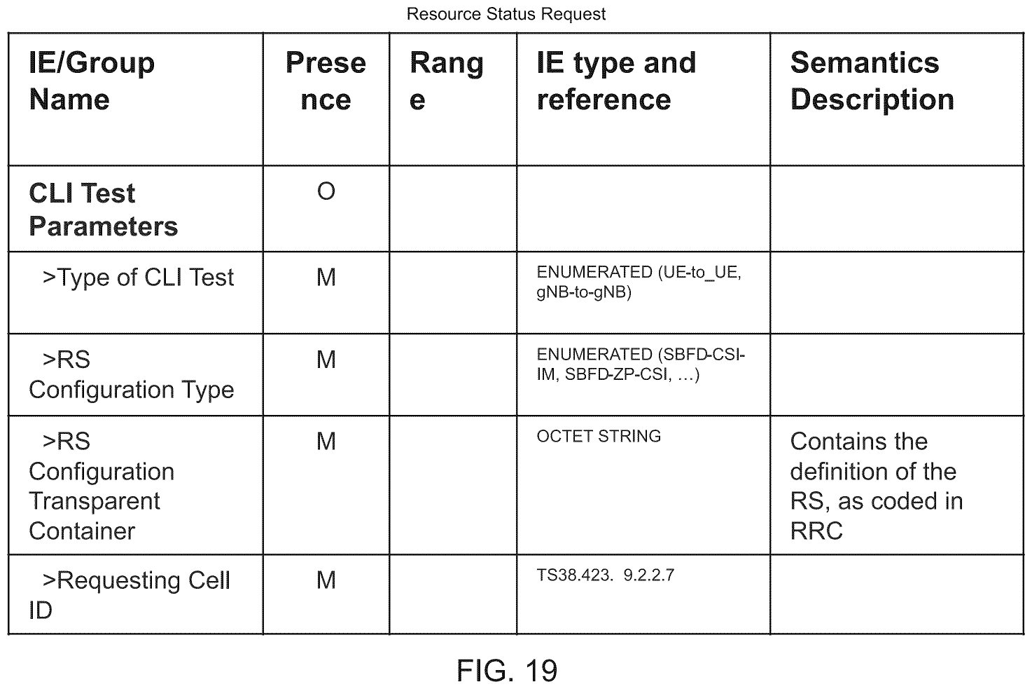

FIG. 19 is an example diagram illustrating resource status request information as discussed herein.

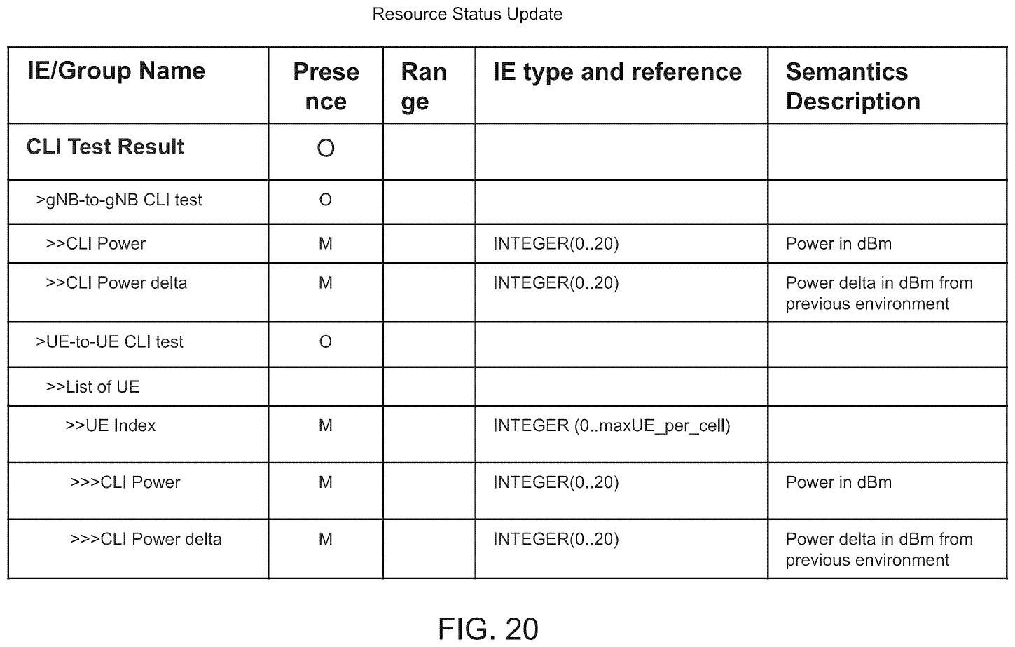

FIG. 20 is an example diagram illustrating resource status updated mission is discussed herein. Add a new IE “CLI Test Result” to the existing “Cell Measurement Result Item” IE. Currently defined Xn Message flow as shown can be used to support coordinated CLI measurements

Current Resource Status request IE needs following modifications to support coordinated CLI measurements.

A configuration as discussed herein can be configured to add a bit 7 to IE “Report Characteristics” to indicate that this request is for “CLI Testing”.

Under “Cell to Report Item”, add a new IE that indicates “CLI Testing”, which could have possible values of “gNB-to-gNB test” or “UE-to-UE” test, or “both”.

Add a new IE “CLI Test Parameters”, which is conditionally present if the “Report Characteristic” IE indicates “CLI Testing”, and the existing “Registration Request” IE indicates “start” or “add”.

Current Resource Status Update IE needs following modifications to support coordinated CLI measurements

### Exemplary Xn Modifications to Resource Status Request and Resource Status Update to Support Coordinated CLI Measurements

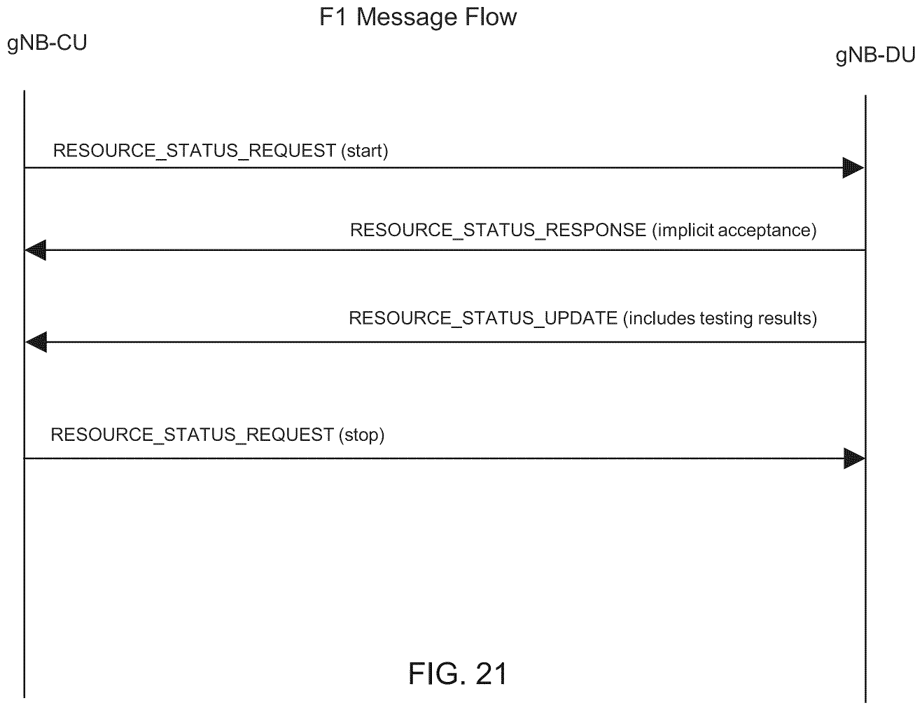

FIG. 21 is an example diagram illustrating F1 message flow as discussed herein.

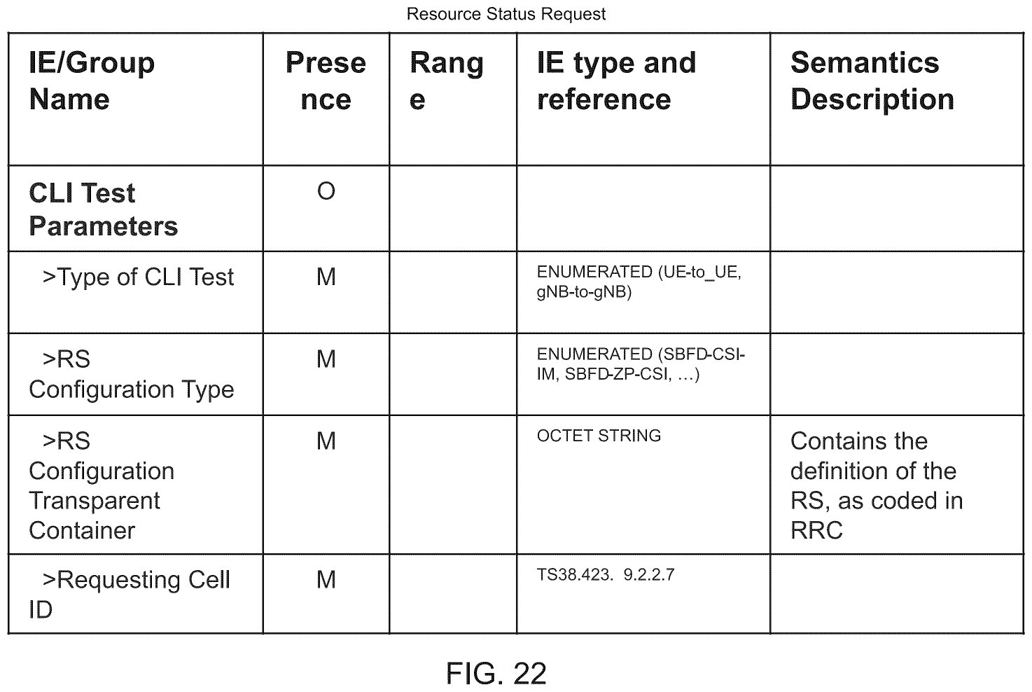

FIG. 22 is an example diagram illustrating resource status West information is discussed herein.

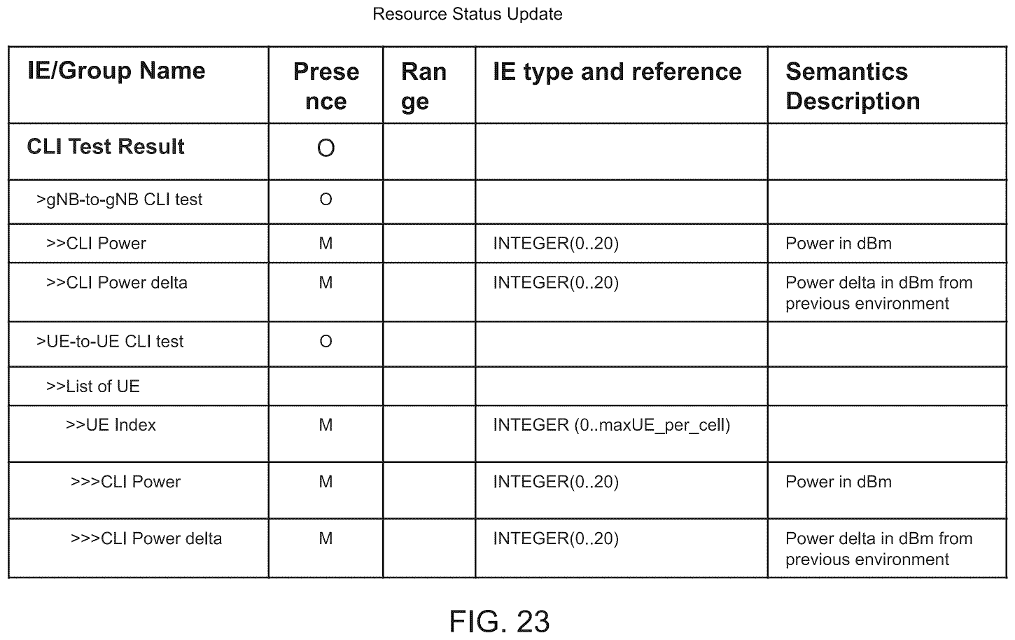

FIG. 23 is an example diagram illustrating resource status update information as discussed herein.

An Xn Message flow as shown can be used to support coordinated CLI measurements.

Current Resource Status request IE needs following modifications to support coordinated CLI measurements.

Examples herein include adding a bit 7 to IE “Report Characteristics” to indicate that this request is for “CLI Testing”.

Under “Cell to Report Item”, examples herein include adding a new IE that indicates “CLI Testing”, which could have possible values of “gNB-to-gNB test” or “UE-to-UE” test, or “both”.

Further examples herein include adding a new IE “CLI Test Parameters”, which is conditionally present if the “Report Characteristic” IE indicates “CLI Testing”, and the existing “Registration Request” IE indicates “start” or “add”.

Current Resource Status Update IE needs following modifications to support coordinated CLI measurements.

Further examples herein include adding a new IE “CLI Test Result” to the existing “Cell Measurement Result Item” IE.

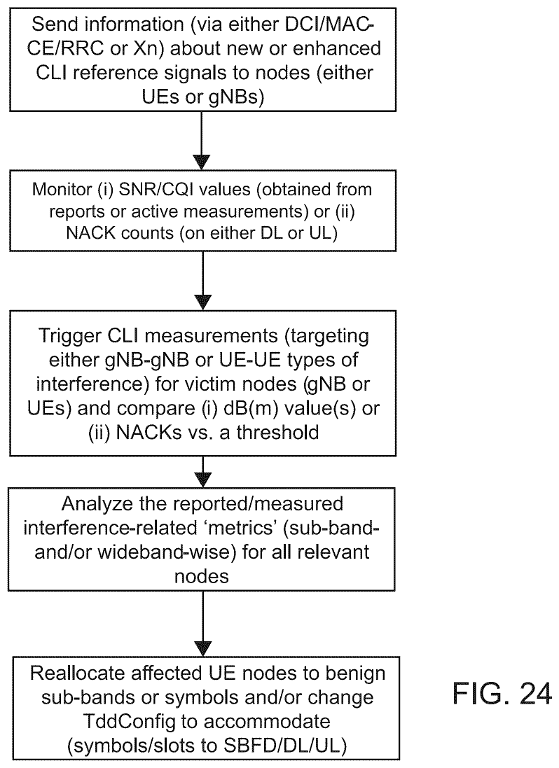

FIG. 24 is an example diagram illustrating implementation of cross-link interference measurements and litigation techniques as discussed herein.

In one example, the network environment 100 includes communication management resource 140. A respective instance of the communication management resource 140 can be disposed in any suitable entity such as wireless base station, mobile communication device, etc.

As shown in flowchart 2400, in processing operation 2410, the communication management resource 140 associated with a respective primary wireless base station in the network environment 100 distributes control information indicating how each of the different wireless stations in the network environment is to implement wireless interference testing. As previously discussed, the control information may include reference signal scheduling information indicating which of one or more first wireless stations (such as mobile communication devices, or other wireless base stations, etc.) in the network environment 100 is to transmit respective reference signals, which are monitored by corresponding one or more second wireless stations in the network environment 100. Note that the reference signal schedule information can be configured to indicate one or more frequencies or channels and one or more timeslots during which the one or more first wireless stations are to transmit the corresponding reference signals. The reference signal schedule information further notifies the one or more second wireless stations of the one or more frequencies or channels and one or more timeslots during which the one or more second wireless stations are to receive the corresponding reference signals transmitted by the one or more first wireless stations.

In processing operation 2420, the communication management resource 140 monitors a performance or ability of the primary wireless base station to transmit wireless communications from the wireless base station in the downlink direction to one or more different mobile communication devices in the network environment 100. Such performance monitoring may include the communication management resource 140 receiving performance feedback from the one or more different mobile communication devices. The performance feedback from the one or more different mobile communication devices indicates a respective performance of each of those communication devices to receive respective wireless communications transmitted by the wireless base station in the downlink direction. Alternatively, the primary wireless base station can be configured to monitor wireless communications received from the one or more different mobile communication devices in the uplink direction. In either case, performance quality can be determined based upon signal-to-noise information or channel quality indicators associated with any of the wireless stations receiving wireless signals. Based on the performance quality of downlink communications and/or performance quality of uplink communications, the wireless base station is able to determine a respective performance associated with each of the corresponding uplink or downlink connections between the primary wireless base station and the mobile communication devices being monitored.

In processing operation 2430, in response to detecting that respective performance of wirelessly communicating falls below a threshold level, the communication management resource 140 associated with the primary wireless base station triggers the one or more wireless stations in the network environment 100 to perform operations associated with the wireless interference testing based on the determined link quality in processing operation 2420. For example, a first wireless station transmits one or more reference signals in accordance with the reference signal schedule information while a second wireless station determines wireless interference associated with receiving the one or more reference signals. The one or more wireless stations configured to perform the signal monitoring generate wireless interference information indicating a degree of wireless interference associated with receiving the corresponding reference signals. Thus, as its name suggests, the wireless interference testing as discussed in operation 2430 enables the communication management resource 140 and corresponding primary wireless base station to determine a source of the wireless interference causing respective uplink or downlink quality to be below a threshold level.

In processing operation 2440, the communication management resource 140 analyzes the reported wireless interference as measured or determined by the one or more second wireless stations to determine occurrence of wireless interference above a threshold level.

In processing operation 2450, based on the determined interference as reported by each of the one or more second wireless stations (which may include the primary wireless base station), the communication management resource 140 performs interference mitigation by reallocating any identified wireless stations experiencing wireless interference above a threshold to one or more different channels or sub-frequency bands where the identified wireless stations will experience less wireless interference. Additionally, the communication management resource 140 can be configured to modify a respective TDD configuration to alleviate the detected wireless interference.

Additional details of implementing the wireless interference testing is further discussed below.

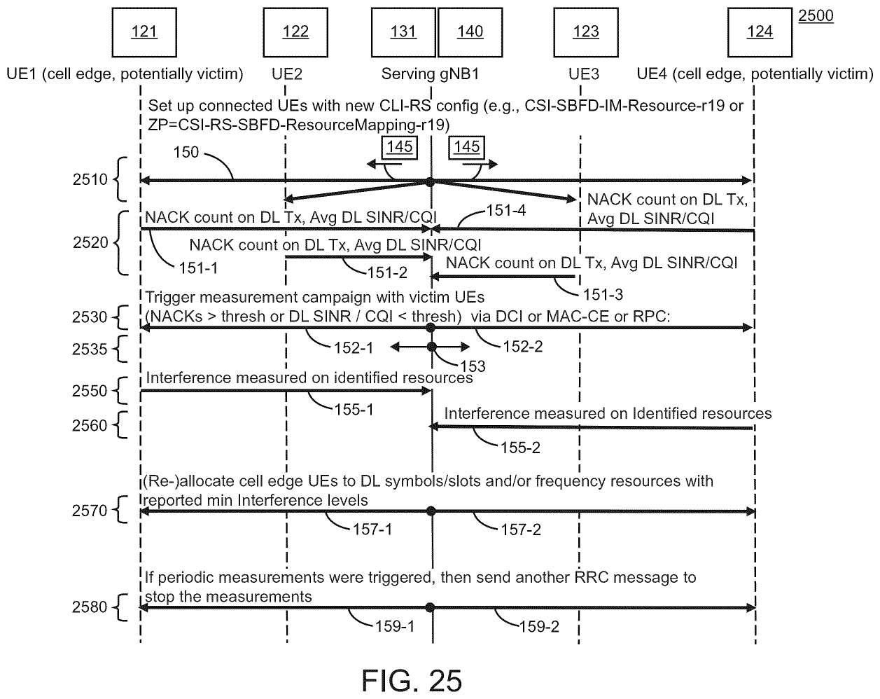

FIG. 25 is an example diagram illustrating first wireless interference mitigation (e.g., Un-coordinated UE-to-UE interference mitigation) without changing a time division duplex uplink downlink configuration as discussed herein.
The following wireless interference testing procedure enables a respective wireless base station 131 (gNB1) to mitigate UE-to-UE interference without changing TDD-UL-DL-Configuration. This is achieved by determining the wireless interference and then (re-)allocating different wireless resources (wireless channel, or a frequency, some bands, symbols, etc.) that experience the wireless interference. In this example, the mobile communication devices (UEs) such as mobile communication device 121 (a.k.a., UE1 or wireless station), mobile communication device 122 (a.k.a., UE2 or wireless station), mobile communication device 123 (a.k.a., UE3 or wireless station), and mobile communication device 124 (a.k.a., UE4 or wireless station), etc., in wireless communication with the wireless base station report UE-to-UE interference levels for processing by the wireless base station and corresponding communication management resource 140.
   In one example, as shown in FIG. 25, via respective wireless notifications transmitted to the mobile communication devices, the wireless base station gNB1 configures all of its UEs (121, 122, 123, 124, etc.) with control information such as reference signal schedule information 145 (a.k.a., cross-link interference testing information) indicating new CLI reference signal(s) (e.g., CSI-SBFD-IM-Resource-r19 or ZP-CSI-RS-Resource using the (novel) ZP-CSI-RS-SBFD-ResourceMapping-r19 IE) to support wireless interference testing as discussed herein.
      In one example, the reference signal schedule information 145 indicates when reference signals will be transmitted and over what frequency/bands/channels or type of encoding of reference signals by the wireless base station 131 will subsequently be used to transmit the one or more reference signals so that the corresponding mobile communication devices 121, 122, 123, 124, etc., know when and, in general, how to detect and monitor signal strengths of such signals. The reference signal schedule information 145 can be transmitted or distributed to other wireless stations in any suitable manner. In one example, the reference signal schedule information 145 is transmitted by the wireless base station 131 (such as via an RRC in PDCCH-Config or other method) after each of the UEs (121, 122, 123, etc.) attaches itself (once in RRC_CONNECTED state) to the wireless base station 131 (gNB1), or as a need arises. In other words, the reference signal schedule information 145 can be distributed at any suitable time to the wireless stations. Note that communication of the reference signal schedule information 145 itself may not cause mobile communication devices to monitor for reference signals. As further discussed herein, the wireless base station 131 can be configured to send a command to notify the one or more communication devices when to monitor for reference signals transmitted by the wireless base station 131.
   Further in this example, via wireless transmission of the one or more second notifications to the mobile communication devices indicating to implement cross-link interference measurements, note that a gNB (e.g., gNB1 or wireless base station 131) can start or execute a respective un-coordinated UE-to-UE reference signal measurement mode, in response to the wireless base station 131 detecting one or more UEs connected to it that are reporting bad SNR/CQI or a high number of NACKS (referred to as ‘victim’ UEs) above a threshold level. In other words, if the wireless base station 131 detects poor performance of wireless communication link between the wireless base station 131 and one or more of the mobile communication devices below threshold level, this indicates wireless interference. In such an instance, the wireless base station 131 notifies those mobile communication devices to execute the wireless interference testing as defined in the reference signal schedule information 145 (a.k.a., wireless interference test control information).
   Note that the wireless base station 131 such as gNB1 can involve in measurement(s) all UEs connected to it or just victim UEs that experience poor wireless performance below a threshold level of receiving communications from the wireless base station 131 or poor wireless performance below a threshold level of transmitting communications from the respective user equipment to the wireless base station 131.
      In this example, any UEs involved in UE-to-UE measurements will be called “CLI Measuring UEs”
      note that reference signal measurements can be configured to support the wireless interference testing can be aperiodic (triggered via DCI) or semi-persistent (triggered via MAC-CE) or periodic (triggered via RRC).
   In one example, the gNB1 will notify the CLI Measuring UEs (i.e., one or more instances of user equipment notified to monitor for reference signals transmitted from the wireless base station 131 in accordance with the reference signal schedule information 145) to report back specified sub-band as well as wideband wireless interference levels is detected by the respective instance of user equipment measuring the wireless reference signals transmitted by the wireless base station 131. In one example, the wireless interference feedback reports produced by the one or more instances of user equipment may be collected by the gNB1 per OFDM symbol per time slot per frame.
   Based on the reported user equipment feedback indicating sub-band and wideband interference power levels, the wireless base station 131 performs operations to mitigate the detected wireless interference.
      For example, the wireless base station gNB1 can be configured to allocate, DL, sub-bands and/or symbols with lowest interference levels, to those instances of UEs reporting UE-to-UE wireless interference (e.g., cell edge UEs) above a respective threshold level.
      Note further that, if execution of the wireless interference measurements in accordance with the reference signal schedule information were initially triggered as being periodic (i.e., via RRC) and continuous, the wireless base station 131 can be configured to wirelessly transmit a subsequent termination command such as another RRC message to one or more of the respective instances of user equipment to disable them from further implementing the wireless interference testing.

Now with reference to flowchart 2500, in processing operation 2510, via the communication management resource 140 or other suitable entity, the wireless base station 131 (a.k.a., serving gNB1) sets up all the connected UEs (i.e., mobile communication devices 121, 122, 123, 124,)) with the reference signal scheduling information 145 such as including new CLI-RS configurations (e.g., CSI-SBFD-IM-Resource-r19 or ZP-CSI-RS-Resource using the (novel) ZP-CSI-RS-SBFD-ResourceMapping-r19 IE). In one example, the wireless base station 131 transmits the reference signal schedule information 145 in communications 150 to each of the connected mobile communication devices.

Note that communication of the reference signal schedule information 145 can occur at any time. In one example, the wireless base station 131 transmits the reference signal schedule information supporting wireless interference testing such as when a respective UE attaches itself with the wireless base station 131. Alternatively, the wireless base station 131 can be configured to transmit the reference signal schedule information 145 at any other time when cross-link interference testing is desired.

In a further example, configuration information (a.k.a., reference signal schedule information 145) defines time (OFDM symbols/slots) as well as frequency resources across different sub-bands where the wireless base station 131 is configured to transmit one or more reference signals for analysis by the respective mobile communication devices.

In processing operation 2520, the wireless base station 131 receives the link quality feedback information from each of the mobile communication devices 121, 122, etc., receiving wireless signals from the wireless base station 131. For example, the wireless base station 131 receives wireless communications 151-1 (feedback indicating number of instances in which the mobile communication device 121 fails to properly receive wireless downlink communications from the wireless base station 131, which may be based on NACKs, wireless power level at which the mobile communication device 121 receives wireless signals from the wireless base station 131, average downlink SINR/CQI, etc.) from the mobile communication device 121; the wireless base station 131 receives wireless communications 151-2 (feedback indicating number of instances in which the mobile communication device 122 fails to properly receive wireless downlink communications from the wireless base station 131, which may be based on NACKs, wireless power level at which the mobile communication device 122 receives wireless signals from the wireless base station 131, average downlink SINR/CQI, etc.) from the mobile communication device 122; the wireless base station 131 receives wireless communications 151-3 (feedback indicating number of instances in which the mobile communication device 123 fails to properly receive wireless downlink communications from the wireless base station 131, which may be based on NACKs, wireless power level at which the mobile communication device 123 receives wireless signals from the wireless base station 131, average downlink SINR/CQI, etc.) from the mobile communication device 123; the wireless base station 131 receives wireless communications 151-4 (feedback indicating number of instances in which the mobile communication device 124 fails to properly receive wireless downlink communications from the wireless base station 131, which may be based on NACKs, wireless power level at which the mobile communication device 124 receives wireless signals from the wireless base station 131, average downlink SINR/CQI, etc.) from the mobile communication device 124; and so on.

In one example, the wireless base station 131 uses the respective feedback (such as communications 151) from the mobile communication devices to determine which of the mobile communication devices reside at a respective edge of the wireless cell (region of wireless coverage) provided by the wireless base station 131. In one example, based on the feedback in communications 151, the wireless base station 131 determines that cell edge UEs (e.g., UE1 and UE4 such as communication device 121 and communication device 124) are transmitting a lot of NACKs and reporting low SINR or CQI (Channel Quality Indicators) values below threshold level. Thus, such communication devices 121 and 124 receive wireless signals transmitted from the wireless base station 131 below a performance threshold level. Such a condition (poor link quality) can be configured to trigger the wireless base station 131 to perform wireless interference testing at least with respect to mobile communication device 121 and 124 to determine a source of the wireless interference and potentially how to reduce a.

In processing operation 2530, in response to detecting that the link performance (performance of wireless link between the wireless base station 131 and the mobile communication device 121 and performance of the wireless link between the wireless base station 131 and the mobile communication device 124) associated with each of the mobile communication device 121 and the mobile communication device 124 is below a threshold level, the wireless base station 131 transmits communications 152-1 to the mobile communication device 121; the wireless base station 131 transmits wireless communications 152-2 to the mobile communication device 124.

The communications 151-1 and 151-2 notify the mobile communication devices 121 and 124 to operate in reference signal measurement mode (a.k.a., cross-link interference testing mode) as indicated or defined by the reference signal schedule information 145.

In processing operation 2535, via communications 153, the wireless base station 131 transmits one or more reference signals as indicated by the reference signal schedule information 145 to the mobile communication device 121 and the mobile communication device 124. In one example, communications 152-1 and 152-2 from the wireless base station 131 may trigger this measurement campaign (reference signal measurements) by all connected UEs if desired for a subset of communication devices such as mobile communication device 121 and the mobile communication device 124. In one example, the trigger to perform the wireless interference testing is indicated by the communications 152-1 and 152-2, which may further indicate how the wireless interference measurements will be generated by the respective mobile communication devices and reported back to the wireless base station 131 in processing operation 2550 and 2560.

Note that the reference signal measurements by the mobile communication devices may be aperiodic (sent via DCI or other type of communication) or Semi-persistent (sent via MAC-CE or other type of communication) or periodic (sent via RRC or other type of communication).

In one example, in response to receiving communications 152-1 and 152-2, the mobile communication device 121 and the mobile communication device 122 measure wideband wireless interference levels detected by the respective mobile communication device during monitoring of the one or more reference signals (communications 153) transmitted by the wireless base station. Additionally, the mobile communication device 121 and the mobile communication device 122 can be configured to measure sub-band wireless interference associated with receiving the one or more reference signals (communications 153) as indicated by the reference signal schedule information 145.

In processing operation 2550, the mobile communication device 121 transmits communications 155-1 including the measured wireless interference associated with the mobile communication device 121 receiving the reference signals (153) from the wireless base station 131.

In processing operation 2560, the mobile communication device 124 transmits communications 155-2 including the measured wireless interference associated with the mobile communication device 124 receiving the reference signals (153) from the wireless base station 131.

If desired, in accordance with another example, all the “CLI measuring UEs” such as mobile communication device 121, mobile communication device 124, etc., will transmit back sub-band and wideband interference levels that were measured on the indicated time and frequency resources (as indicated by the reference signal schedule information 145) by the serving cell (wireless base station 131).

A further example, the wireless base station 131 and corresponding communication management resource 140 can be configured to average the interference levels across different time (OFDM symbols/slots) and frequency resources for each instance of feedback received from the respective mobile communication devices 121 and 124.

In processing operation 2570, based on the degree of wireless interference associated with wireless signal reception by the mobile communication device 121 and the mobile communication device 124 as determined from the communications 155-1 and 155-2, the wireless base station 131 and corresponding communication management resource 140 can be configured to (re-)allocate wireless resources to the UEs in the time domain (OFDM symbols/slots) and frequency domain to reduce wireless interference associated with the mobile communication device receiving wireless signals from the wireless base station 131.

More specifically, the wireless base station 131 can be configured to transmit the wireless communications 153 (reference signals) at a specific frequency or channel. In a case where the mobile communication devices 121 and 124 receive the transmitted reference signals with a high level of wireless interference in a first wireless channel, the communication management resource 140 can determine that there is a high amount of wireless interference in the first wireless channel. As previously discussed, the high amount of wireless interference may be caused by other wireless stations (nearby the mobile communication devices 121 and 124) communicating in the network environment 100. The wireless base station 131 can be configured to discontinue use of the first wireless channel to communicate with the mobile communication devices 121 and 124, and instead use a second wireless channel to communicate in the downlink direction from the wireless base station 131 to the mobile communication devices 121 and 124. Note that the reference signal schedule information 145 may include a configuration of the wireless base station 131 also transmitting reference signals in the second wireless channel for monitoring by the mobile communication devices 121 and 124. The feedback from the mobile communication device 121 in communications 155-1 may indicate that the amount of wireless interference associated with the communication device 121 receiving the communications 153 in the second wireless channel is below a threshold level; the feedback from the mobile communication device 124 in communications 155-2 may indicate that the amount of wireless interference associated with the communication device 124 receiving the communications 153 in the second wireless channel is below a threshold level as well. In such an instance, because the wireless interference associated with the second wireless channels below the threshold level, the wireless base station 131 implements use of the second wireless channel to transmit wireless downlink communications from the wireless base station to the mobile communication devices 121 and 124.

In processing operation 2580, if measurements triggered by the reference signal schedule information 145 were configured as periodic, then the wireless base station can be configured to transmit communications 159-1 (such as an RRC message or other suitable message), causing the mobile communication device 121 to discontinue implementing the wireless interference testing is indicated by the reference signal schedule information 145. In similar manner, the wireless base station 131 can be configured to transmit communications 159-2 to the mobile communication device 124, causing the mobile communication device 124 to discontinue implementing the wireless interference testing as indicated by the reference signal schedule information 145.

Accordingly, examples herein include: at a first wireless station (131): establishing wireless connectivity with multiple wireless stations (121, 122, 123, 124) including a second wireless station (121); transmitting a first notification (150) to the multiple wireless stations, the notification including reference signal schedule information (145) indicating a schedule for monitoring at least one reference signal; and transmitting a second notification (152-1, 152-2), the second notification triggering the second wireless station (121) to monitor the at least one reference signal (153) as indicated by the reference signal schedule information (145).

In a further example, the at least one reference signal (153) includes a first wireless reference signal. The first wireless station (131) transmits the first wireless reference signal to the second wireless station (121) as indicated by the schedule (145).

In another example, in response to the first wireless station (131) transmitting the at least one reference signal as indicated by the reference signal schedule information (145), the first wireless station (131) receives (155-1) from the second wireless station (121), the feedback indicating a magnitude of wireless interference associated with the second wireless station receiving the at least one reference signal (153) transmitted by the first wireless station (131).

In a further example, a communication management resource 140 associated with the first wireless station (131) compares the magnitude of wireless interference (as indicated by 155-1) to a threshold level; and in response to detecting that the magnitude of the wireless interference as indicated by the communications 155-1 is greater than the threshold level, the communication management resource 140 and corresponding first wireless station (131) modifies which wireless resources (such as first wireless channel, second wireless channel, etc.) that are allocated to support a wireless connection between the first wireless station (131) and the second wireless station (121).

Still further examples as discussed herein include the first wireless station (131) transmitting the second notification (152-1) to the second wireless station (121) in response to detecting that a performance of a wireless communication link between the first wireless station and the second wireless station falls below a threshold level. As previously discussed, the performance of the wireless communication link between the first wireless station (131) and the second wireless station (121) can be determined in any suitable manner.

In one example, the communication management resource 140 and corresponding first wireless station (131) determines the performance of the wireless communication link between the first wireless station (131) and the second wireless station (121) based on feedback (communications 155-1) from the second wireless station (121) indicating an inability of the second wireless station (121) to receive wireless communications transmitted in a downlink direction from the first wireless station to the second wireless station.

In another example, the communication management resource 140 corresponding first wireless station (131) determines the performance of the wireless communication link between the first wireless station and the second wireless station based on feedback from the second wireless station, the feedback indicating a wireless power level at which the first wireless station receives wireless communications (153) such as one or more reference signals transmitted from the first wireless station.

Yet further, the reference signal schedule information can be configured to indicate a frequency and time (time domain and frequency domain) that the first wireless station (131) is scheduled to transmit a first wireless reference signal of the one or more reference signals scheduled for transmission from the first wireless station (131).

As previously discussed, the wireless base station 131 can be configured to transmit the reference signals in any suitable manner. In one example, the wireless base station 131 transmits the reference signals (153) in accordance with a particular selected encoding, which is indicated by the reference signal schedule information so that the participating second wireless station (121) is able to determine how to monitor for presence of the reference signal transmitted by the first wireless station (131) or other suitable entity. Accordingly, the reference signal schedule information (145) can be configured to indicate an encoding configuration assigned to transmitting the at least one reference signal.

It is further noted that the one or more reference signals (153) transmitted by the first wireless station (131) or other suitable entity can be scheduled for transmission via one or more symbols scheduled for transmission from the first wireless station in a particular time slot. The reference signals (153) may be transmitted in a set of contiguous transmitted symbols in a particular time slot or the reference signals (153) may be transmitted in a set of non-contiguous transmitted symbols in a particular time slot. As previously discussed, the reference signal schedule information (145) can be configured to indicate timing of transmitting the one or more symbols (reference signals) in a timeslot. In such an instance, the mobile communication devices are notified what one or more symbols of reference signals to monitor.

Still further, it is noted that the reference signal schedule information (145) can be configured to indicate multiple different frequency bands or channels to be monitored by the second wireless station (121) for detection of the at least one reference signal (153) transmitted by the first wireless station (131). In response to transmitting the second notification (152-1), the first wireless station (131 receives feedback (155-1) from the second wireless station, the feedback indicates different levels of wireless interference associated with the second wireless station (121) receiving the at least one reference signal (153) in the multiple different frequency bands.

As previously discussed, the communication management resource 140 and/or corresponding wireless base station 131 can be configured to perform wireless interference mitigation such that the affected mobile communication device 121 is provided a better wireless communication link with the wireless base station 131. In one example, in response to the communication management resource 140 or first wireless station (131) determines that a first frequency band or first wireless channel of the multiple different frequency bands or multiple wireless channels at which the second wireless station (121) receives the at least one reference signal (153) below an interference threshold level, the first wireless station (131) allocates future use of the first frequency band or first wireless channel to support a first wireless communication link between the first wireless station (131) and the second wireless station (121).

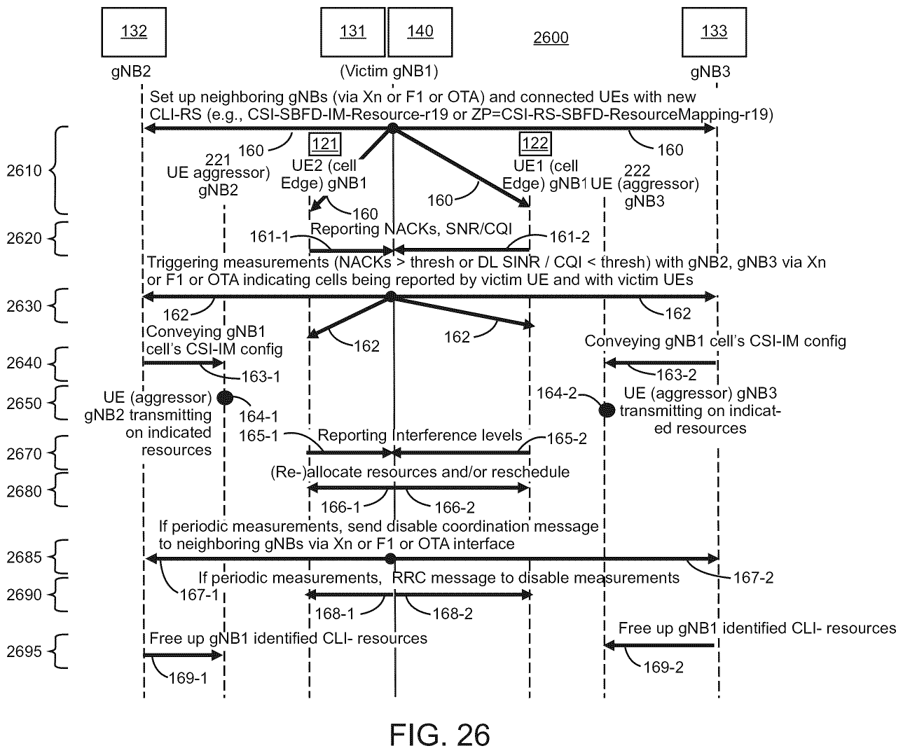

FIG. 26 is an example diagram illustrating first wireless interference mitigation (e.g., UE-to-UE interference mitigation (i) without a TDD Configuration Change and (ii) with coordination across neighbor gNBs) as discussed herein.
In this example, the wireless base station 131 such as gNB1 and corresponding communication management resource 140 mitigates UE-to-UE interference without changing TDD-UL-DL-Configuration used by the wireless base station 131 to communicate with the corresponding mobile communication devices. The mitigation is achieved via coordination of using wireless resources (such as wireless channels, wireless sub-bands, wireless bandwidth, etc.) with neighboring wireless base stations such as wireless base station gNB2, wireless base station gNB3, etc.), by (re-)allocating any wireless interference affected UEs to downlink sub-bands and or symbols where there is less interference. This may be based on determining the level of UE-to-UE interference levels reported by the UEs (a.k.a., mobile communication devices).
In this example, in a similar manner as previously discussed, the wireless base station 131 such as gNB1 configures one or more UEs with new CLI reference signal(s) is indicated by the reference signal schedule information 145 supporting wireless interference testing (e.g., CSI-SBFD-IM-Resource-r19 or ZP-CSI-RS-Resource using the (novel) ZP-CSI-RS-SBFD-ResourceMapping-r19 IE).
Note that the configuration information such as the reference signal schedule information 145 may be conveyed (via RRC in PDCCH-Config) after a UE attaches itself (once in RRC_CONNECTED state) to the gNB, or as a need arises.
Further, note that the wireless base station 131 such as gNB1 may exchange same CLI reference signal information with its neighboring gNBs (e.g., gNB2, gNB3), via any suitable communication interface such as communication interface Xn or communication interface F1 or, yet further, using OTA IM-RS-r19 CONFIGURATION 1 signal as previously discussed.
In general, to determine UEs of neighboring gNBs that are causing wireless interference, the wireless base station 131 such as gNB1 may time or code multiplex UE transmissions from neigboring gNBs for monitoring by one or more instances of user equipment (a.k.a., mobile communication devices).
Via the reference signal scheduling information 145 or other suitable information, those determined UEs wirelessly connected to the neighboring gNB will be configured to either transmit reference signals such as via any NZP data or IM-RS-r19 type signal time multiplexed (at specified times) or will spread the IM-RS-r19 configuration 2 type signal with provided unique codes or cell ID of the interfering cell.
Further, the wireless base station 131 such as gNB1 will trigger coordinated UE-to-UE measurement campaign with its neighboring gNBs (e.g., gNB2, gNB3 etc) as well as within its own network, if the wireless base station 131 detects that UEs (e.g., cell edge UEs) connected to the wireless base station 131 are reporting bad SNRs or high number of NACKS (poor wireless link performance) via the wireless communication between those instances of mobile communication devices 121 and 122 in this example.
A further example, triggering of the wireless interference testing as discussed herein may be achieved via communications over the Xn interface or F1 interface or OTA (Over The Air). In one example, the wireless base station 131 (such as a victim gNB) notifies (such as via the reference signal scheduling information 145) the mobile communication devices 121 and 122 of the neighboring gNB that will transmit respective reference signals to be monitored by the mobile communication devices 121 and 122. The notification to the communication devices may indicate how to perform wireless interference measurements (aperiodic, semi-persistent or periodic) associated with the mobile communication devices 121 and 122 receiving reference signals from the user equipment (of a different wireless network) such as mobile communication device 221 and mobile communication device 122 transmitting those reference signals.
In a further example, note that the trigger notification generated by the wireless base station 131 or other suitable entity to perform the wireless interference testing may also include the information of the cell ID of neighboring gNBs (e.g., gNB2, gNB3) that victim UEs (121, 122) of wireless base station 131 such as gNB1 have detected while performing a cell search of potentially wireless interfering devices. In such an instance, neighboring gNBs (e.g. gNB2, gNB3) will use cell ID (Identity) information to configure the UEs (121, 122) in the indicated cells (region of wireless coverage associated with wireless base station gNB2 and region of wireless coverage provided by wireless base station gNB3) to transmit NZP signal on indicated CLI resources (cell ID may also be used as a unique code to spread indicated CLI-RSs)
The wireless base station gNB1 will trigger its UEs (either all or only victim UEs) with measurement that can be apriodic (triggered via DCI) or semi-persistent (triggered via MAC-CE) or periodic (triggered via RRC)
UEs (such as mobile communication device 121 and mobile communication device 122) involved in UE-to-UE measurements will be called “CLI Measuring UEs”
Based on the reported sub-band and wideband interference levels as detected by the mobile communication device 121 and mobile communication device 122, the wireless base station 131 such as gNB1 will perform one or more of the following operations:
The communication management resource 140 or corresponding wireless base station 131 (gNB1) determines which UEs of neighboring gNBs (e.g. gNB2, gNB3) are affecting its UEs (e.g. cell edge UEs) at a given instance on allocated resources
The wireless base station 131 such as gNB1 will allocate, DL, sub-bands and/or symbols with lowest interference levels, to UEs seeing UE-to-UE interference (e.g., cell edge UEs). In other words, the respective mobile communication device 121 monitors wireless interference caused by mobile communication device 221 based on the one or more reference signals transmitted by the mobile communication device 221. The wireless base station 131 selects wireless bands or frequencies were channels to communicate with the mobile communication device 121 where the detected wireless interference is lower than a threshold level.
The wireless base station 131 such as gNB1 may also coordinate with the neighboring gNB(s) (e.g. gNB2, gNB3), whose UEs (mobile communication device 221, mobile communication device 222, etc.) are interfering with its connected UEs (mobile communication device 121, mobile communication device 122, etc.), via any suitable interface such as Xn or F1 interface, etc.
   Note that the coordination by the wireless base station 131 (and the first wireless network) may include a request to mute (prevent certain wireless communications from being transmitted from) certain UL REs (e.g. not allocating those for UL transmission) in certain symbols or sub-bands.
   Further, note that the coordination by the wireless base station 131 with the wireless base station 132 (in the second wireless network) may include a request by the wireless base station 131 to reduce the power levels transmitted by the wireless base station gNB2 or wireless base station gNB3 in certain UL REs (channels or resource blocks or any wireless resources used to communicate in an uplink direction from the mobile communication devices 121 and 122 to the wireless a station 131) for a period of time
   Additionally, note that if the measurements associated with testing the wireless interference were periodic, then the wireless base station 131 or other suitable entity can be configured to send another command such as via another RRC message in gNB1's network to disable measurements by the user equipment (mobile communication devices 121, 122, etc.) in its own network, which may include setting one or more wireless messages via Xn or F1 interface to disable coordination in the neighboring gNBs

Now, with reference to the flowchart 2600, in processing operation 2610, the wireless base station 131 such as gNB1 (victim gNB in the first wireless network) transmits communications 160 to configure its connected UEs (such as mobile communication device 121, mobile communication device 122, etc.) as well as all the neighboring gNBs (wireless base station gNB2, wireless base station gNB3) with the reference signal scheduling information 145 (a.k.a., wireless signal configuration testing information) such as new CLI-RS configurations (e.g., CSI-IM or new ZP-CSI-RS). As previously discussed, the reference signal schedule information 145 defines attributes of when one or more first wireless stations in the network environment 100 are to transmit respective wireless reference signals while one or more second wireless stations are to monitor those transmitted reference signals.

The configuration of the mobile communication devices 121 and 122 via communications 160 can occur at any time. In one example, the wireless base station 131 configures the mobile communication devices 121 and 122 when each of the corresponding instances of user equipment attaches itself (establishes a wireless communication link) with the wireless base station 131 such as gNB1 (establishes a wireless communication link) or aperiodically on a need basis.

The configuration of the neighboring gNBs such as wireless base station gNB2, wireless base station gNB3, etc., via communications 160 may occur when a new gNB gets activated in the second wireless network or aperiodically on an as needed basis.

As previously discussed, the configuration information such as the reference signal schedule information 145 can be configured to define information associated with transmitting or monitoring reference signals such as indicating time (OFDM symbols/slots) as well as frequency resources across different sub-bands that are to be used to transmit the reference signals. This enables the user equipment such as mobile communication device 221, mobile communication device 222, etc., to be notified by their respective wireless base station gNB2 or wireless base station gNB3 regarding when the corresponding user equipment in those different networks is to transmit the one or more reference signals either as time multiplexed or as code multiplexed.

In processing operation 2620, the wireless base station 131 (gNB) such as a Victim gNB receives communications 161-1 from the mobile communication device 121 and the communications 161-2 from the mobile communication device 122. The communications 161-1 indicate link quality associated with the mobile communication device 121 receiving wireless communications in the downlink direction from the wireless base station 131 and the communications 161-2 indicate link quality associated with the mobile communication device 122 receiving wireless communications in the downlink direction from the wireless base station 131.

Based upon these communications, the wireless base station 131 determines that the mobile communication devices 121 and 122 are so-called cell edge UEs (e.g., UE1 and UE2) because the communications 161-1 indicate that the performance of the mobile communication device 121 receiving wireless communications from the wireless base station 131 falls below a respective threshold level and because the communications 161-2 indicate that the performance of the mobile communication device 122 receiving wireless communications from the wireless base station 131 falls below a respective threshold level. In one example, the communications 161-1 and 161-2 indicate information such as NACKs (Now Acknowledgments) and reporting low SINR (Signal Interference Noise Ratio) or CQI (Channel Quality Indicators) values. In this example, such information below a threshold level indicates poor link quality of the mobile communication devices 121 and 122 receiving the downlink communications from the wireless base station 131. As further discussed below, the wireless base station 131 and corresponding communication management resource 140 initiate wireless interference testing via transmission of communications 162 (trigger of executing the reference signal schedule information 145) to learn of the respective source of the wireless interference.

More specifically, in processing operation 2630, the wireless base station 131 and corresponding communication management resource 140 transmit communications 162 to trigger the wireless interference testing and analysis as discussed herein. For example, via communications 162, the wireless base station 131 notifies the wireless base station 132 wireless base station 133 to, in turn, notify their respective communication devices 221 and 222 to transmit reference signals in accordance with the reference signal schedule information 145. The communications 162 further notify the mobile communication device 121 and the mobile communication device 122 to monitor the reference signals that will be transmitted by the mobile communication device 221 and the mobile communication device 222. Accordingly, the Victim gNB can be configured to trigger a measurement campaign with the victim UEs (UE1 and UE2) as well as with neighboring gNBs (gNB2 and gNB3).

Note that the communications 162 may indicate how the wireless interference measurements by the mobile communication devices 121 and 122 should be generated and subsequently reported to the wireless base station 131 and corresponding communication management resource 140.

Further, note that the implementation of the wireless interference testing as discussed herein may be Aperiodic (sent via DCI) or Semi-persistent (sent via MAC-CE) or periodic (sent via RRC).

In accordance with further examples, for neighboring gNBs, the communications 162 such as a respective trigger command may include the cell IDs of neighboring gNBs that were reported by victim UEs (mobile communication device 121 and mobile communication device 122). In other words, the mobile communication devices 121 and 122 may detect the identity of the wireless base station 132 and the wireless base station 133 and report back such wireless base station identities to the wireless base station 131. In this manner, the wireless base station 131 is aware of the network resources potentially causing interference to the mobile communication devices 121 and 122.

Receipt of the communications 162 in processing operation 2630 causes the respective wireless base stations 132 and 133 to notify their respective user equipment to transmit wireless reference signals in accordance with the reference signal schedule information.

For example, in processing operation 2640, in response to receiving the communications 162, the wireless base station 132 (gNB2) transmits communications 163-1 to the mobile communication device 221. The communications 163-1 may include the reference signal schedule information indicating when and how the mobile communication device 221 is to transmit subsequent respective reference signals. Accordingly, the mobile communication device 221 in the second wireless network is made aware of how to and when to transmit the reference signals. In response to the mobile communication device 221 receiving the communications 163-1 and corresponding reference signal schedule information 145, and in accordance with the reference signal schedule information 145, the mobile communication device 221 transmits wireless communications 164-1 (such as one or more reference signals) in the network environment 100 in processing operation 2650.

Recall that the mobile communication device 121 in the first wireless network was also notified via communications 160 of the reference signal scheduling information to perform the wireless interference testing as discussed herein. In processing operation 2650, the mobile communication device 121 monitors the one or more reference signals transmitted from the mobile communication device 221 in accordance with the reference signal schedule information 145. In one example, the mobile communication device 121 produces respective monitor information indicating wireless interference associated with receiving the communications 164-1 (one or more reference signals) transmitted from the mobile communication device 221.

In processing operation 2670, via communications 165-1, the mobile communication device 121 transmits the monitor information associated with monitoring the reference signals transmitted from the mobile communication device 221 (communications 164-1). In one example, the communications 165-1 indicate a wireless interference level for wireless power level associated with receiving the one or more reference signals transmitted in communications 164-1. Accordingly, the wireless base station 131 and corresponding communication management resource 140 are made aware of an amount of wireless interference caused by the transmission of wireless communications from the mobile communication device 221. Note that the reference signals transmitted by the mobile communication device 221 in communications 164-1 may be at multiple different frequencies/channels. The feedback indicated by the communications 165-1 indicate an ability of the mobile communication device 121 to receive those transmitted reference signals at the multiple different frequencies/channels. Based on such feedback, the wireless base station 131 is aware of which channels used by the second wireless network are causing interference to the mobile communication device 121 and which are not causing wireless interference.

In processing operation 2680, the communication management resource 140 and corresponding wireless base station 131 can be configured to use the feedback information in communications 165-1 to mitigate wireless interference in the network environment 100. This may include reallocating different channels (such as wireless channel 3) for use by the mobile communication device 121 in response to detecting that wireless channel 1 and wireless channel 2 used by the mobile communication device 221 cause interference to the mobile communication device 121.

In a similar manner, in processing operations 2640 through 2680 the mobile communication device 122 measures wireless interference of signals transmitted by the mobile communication device 121 and transmits wireless interference reports to the wireless base station 131. The wireless base station 131 performs any suitable mitigation to reduce wireless interference associated with supporting downlink communications to the mobile communication device 122.

Accordingly, in processing operation 2670, all of the “CLI measuring UEs” will transmit back sub-band and wideband interference levels that were measured on the indicated time and frequency resources by the victim cell.

The wireless base station 131 such as victim gNB and corresponding communication management resource 140 can be configured to average the interference levels across different time (OFDM symbols/slots) and frequency resources for each UE (mobile communication device 121, mobile communication device 122, etc.).

Based on the above measurement, in processing operation 2680, the wireless base station 131 such as victim gNB will (re-)allocate the UEs in the time (OFDM symbols/slots) and frequency resources with minimum interference levels to the mobile communication devices 121 and 122.

It is further noted that the wireless base station 131 such as Victim gNB may also negotiate with neighboring gNBs (wireless base station 132, wireless base station 133, etc.) to either mute or reduce UL power from the mobile communication devices 221 and mobile communication device 222) in certain UL resources of their cells to reduce wireless interference with the wireless stations such as mobile communication device 121, mobile communication device 122, wireless base station 131, etc.

If measurements were configurated as periodic then, in processing operation 2690, the wireless base station 131 and corresponding communication management resource 140 can be configured to transmit communications 168-1 such as including an RRC message by the command to disable the measurements in the wireless base stations (132) in neighbor network. The communications to stop the coordination in processing operation 2690 can be transmitted over any suitable interface such as Xn or F1 interface for other interface.

In processing operation 2695, the wireless base station 132 transmits communications 169-1, freeing up wireless bandwidth previously causing wireless interference to the mobile communication device 121.

Thus, examples herein include a first wireless station (131) configured to establish wireless connectivity with multiple wireless stations including a second wireless station (121). The first wireless station (131) transmits a first notification (160) to the multiple wireless stations, where the notification includes reference signal schedule information 145 indicating a schedule for monitoring at least one reference signal. The first wireless station (131) further transmits a second notification (162), where the second notification triggers the second wireless station (121) to monitor the at least one reference signal as indicated by the reference signal schedule information (145).

In one example, the multiple wireless stations include a third wireless station (132) and a fourth wireless station (221). The reference signal schedule information 145 used by the wireless stations in the network environment indicates a schedule for transmitting the at least one reference signal from the fourth wireless station (221) to the second wireless station (121).

In a further example, the first wireless station (131) is a first wireless base station in a first wireless network; the second wireless station (121) is a first mobile communication device in the first wireless network; the third wireless station (132) is a second wireless base station in the second wireless network; the fourth wireless station (221) is a second mobile communication device in the second wireless network. The second mobile communication device (221) is wirelessly connected the a wireless communication link to the second wireless base station (132).

As previously discussed, the second wireless base station (132) is operative to transmit the reference signal schedule information (145) or any portion thereof to the second mobile communication device (221). Transmission of the second notification (162) prompts the second wireless base station (132) to notify the second mobile communication device (221) to transmit the at least one reference signal to the first mobile communication device (121) in a manner as indicated by the reference signal schedule information (145).

Further, as previously discussed, the first wireless base station (131) receives feedback (165-1) from the first mobile communication device (121). In one example, the feedback indicates a magnitude of wireless interference or wireless power level associated with the first mobile communication device (121) receiving the at least one reference signal (164-1) transmitted from the second mobile communication device (221).

In still further examples, the at least one reference signal (164-1) is transmitted over a first wireless channel. In response to detecting that the magnitude of the wireless interference (165-1) is above a threshold level, the wireless base station (131) communicates with the second wireless base station (132) to negotiate discontinued use of the first wireless channel by the second wireless base station (132) and corresponding second mobile communication device (221).

Still further, it is noted that the at least one reference signal (164-1) may be transmitted over a first wireless channel. In response to detecting that the magnitude of the wireless interference as indicated by feedback (165-1) is above a threshold level, the wireless base station 131 and corresponding communication management resource 140 can be configured to allocate use of a second wireless channel by the first mobile communication device (121) as a substitute to the first wireless channel.

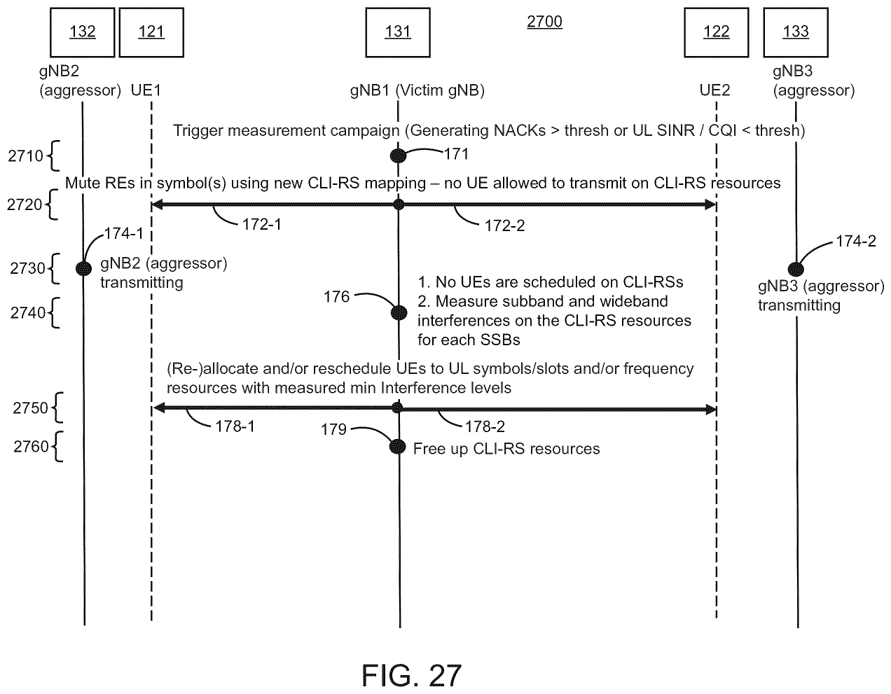

FIG. 27 is an example diagram illustrating wireless interference mitigation without changing TDD Uplink/Downlink Configurations (such as Uncoordinated gNB-to-gNB CLI mitigation) as discussed herein.

In this example, the wireless interference testing as discussed herein enables a gNB to mitigate gNB-to-gNB interference without changing TDD-UL-DL-Configuration, by (re-)allocating any affected UEs in UL sub-bands and/or symbols, where the gNB will measure less gNB-to-gNB interference levels.

A gNB (e.g., wireless base station gNB1 or wireless base station 131) can initiate an uncoordinated gNB-to-gNB measurement campaign if it is detected that there is a problem in receiving UL transmissions from the mobile communication device 121, mobile communication device 122, etc., where the problem is detected based on the wireless base station 131 sending a high number of NACKs to UEs 121, 122, etc., or the wireless base station 131 measuring poor levels of SNR/CQI in the uplink direction from the mobile communication devices 121, 122, etc.

In one example, the wireless base station gNB1 can be configured to terminate use of certain frequencies (REs) per symbol(s) in the UL direction, using the reference signal schedule information 145 such as new CLI resource mapping (e.g., CSI-SBFD-IM-Resource-r19 or ZP-CSI-RS-Resource using the (novel) ZP-CSI-RS-SBFD-ResourceMapping-r19 IE).

In a further example, during these CLI resources in the UL symbols or slots, no UE connected to gNB1 will be allowed to transmit wireless communications.

The wireless base station gNB1 will perform sub-band and wideband interference measurements per symbol on the new CSI resources.

The wireless base station gNB1 may also cycle all its SSBs (different wireless beams) to see how interference from its neighboring gNBs are interfering with different SSBs in different sub-bands per symbol of the wireless base station 131.

Based on the measured sub-band and wideband interference levels: the wireless base station 131 and corresponding communication management resource can be configured to allocate, in the uplink direction UL, sub-bands and/or symbols with lowest detected interference levels, for any UEs detecting high levels of gNB-to-gNB wireless interference; wireless base station 131 such as gNB1 may also mitigate gNB-to-gNB interference by implementing beam nulls in the directions of strongest gNB interferers.

More specifically, in flowchart 2700, the wireless base station 131 such as gNB1 (a.k.a., Victim gNB) detects itself generating large number of NACKs and/or measuring low SINR/CQI values for the received UL transmission from one or more of the mobile communication devices 121, 122, etc. In other words, the wireless base station 131 schedules uplink communications from the mobile communication devices 121, 122, etc., to the wireless base station 131. The wireless base station 131 monitors an ability to receive the transmitted wireless uplink communications from the communication devices 121, 122, etc.

In processing operation 2710, in response to detecting that the performance associated with conveying wireless communications in an uplink direction from one or more of the mobile communication devices 121, 122, etc., to the wireless base station 131 is below a threshold level indicating poor link quality, the wireless base station 131 such as a Victim gNB triggers a measurement campaign using the reference signal schedule information 145 as previously discussed.

In one example, the wireless base station 131 (Victim gNB) will set up new CLI-RS configuration such that no UE in its network will be scheduled to transmit in UL direction in those resources. In other words, in processing operation 2720, via communications 172-1 communicated from the wireless base station 131 to the mobile communication device 121, the wireless base station 131 temporarily terminates uplink communications from the mobile communication device 121 to the wireless base station 131. Via communications 172-2 communicated from the wireless base station to the mobile communication device 122, the wireless base station 131 temporarily terminates uplink communications from the mobile communication device 122 to the wireless base station 131.

In one example, the configuration information communicated to the mobile communication devices 121 and 122 via the communications 172 (as indicated in processing operation 2720) includes a configuration defining time (OFDM symbols/slots) as well as frequency resources across different sub-bands associated with the discontinued communications, where the wireless base station 131 such as a Victim gNB will measure sub-band and wideband interference levels on the new CLI-RS resources from the wireless base station 132 in wireless base station 133.

In processing operation 2730, via communications 174-1, the wireless base station 133 transmits wireless signals in the network environment. Via communications 174-2, the wireless base station 132 transmits wireless signals in the network environment.

In processing operation 2740, while the mobile communication device 121 and the mobile communication device 122 do not wirelessly transmit signals as indicated by communications 172-1 and 172-2, the wireless base station 131 measures the wireless signals (174-1, 174-2) transmitted by the wireless base station 132 and the wireless base station 133.

In a further example, the wireless base station 131 and corresponding communication management resource 140 such as Victim gNB averages the detected interference levels across different time (OFDM symbols/slots) and frequency per symbol associated with the wireless signal transmissions from the wireless base station 132 and wireless base station 133.

Based on the above measurements and data processing, in processing operation 2750, the wireless base station 131 and corresponding communication management resource 140 such as Victim gNB (re-)allocates one or more wireless channels to the UEs in the UL, where the allocated wireless channels correspond to channels where the wireless base station 131 detects the least amount of wireless interference caused by communications from the wireless base stations 132 and 133.

In processing operation 2760, the wireless base station 131 frees up CLI-RS resources and terminates the measurement campaign previously triggered via communications 171.

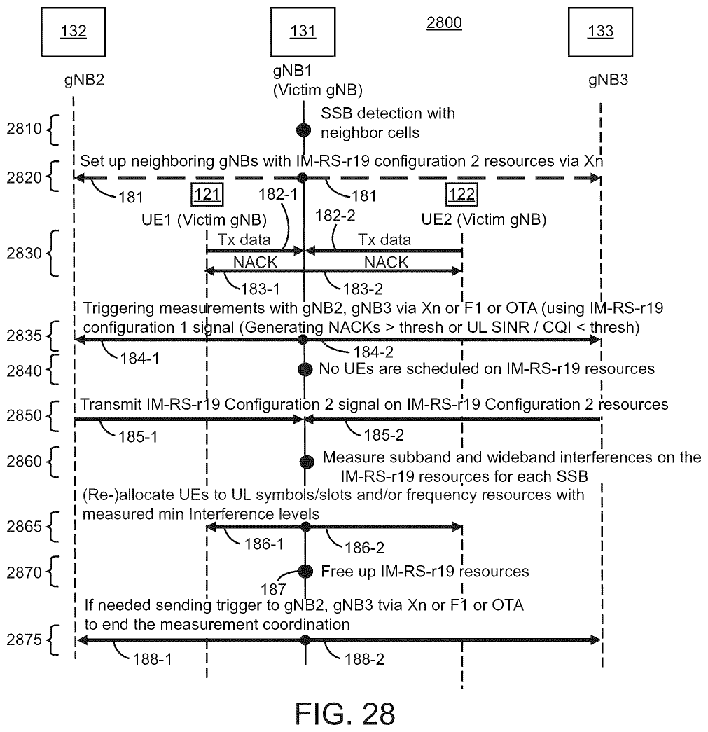

FIG. 28 is an example diagram illustrating wireless interference mitigation without changing TDD Uplink/Downlink Configurations (such as (gNB-to-gNB interference mitigation w/designing gNB specific CLI-RS (i) w/o TDD Configuration Change and (ii) with coordination across neighboring gNBs with unique RS) as discussed herein.

This example implementation of implementing wireless interference testing enables a victim gNB (e.g. such as wireless base station gNB1) to mitigate gNB-to-gNB interference without changing TDD-UL-DL-Configuration, in coordination with neighboring gNBs (e.g. gNB2, gNB3), by (re-)allocating any affected UEs in UL sub-bands and or symbols, that gNB1 will measure to have less gNB-to-gNB interference levels.

Initially, a gNB specific CLI Reference Signal (RS) is designed, where:
a reference signal such as RS sequence may be designed using Zadoff-Chu sequence as the base sequence and cell ID or a cell specific unique signature is used to either scramble or send along with new CLI-RS
the reference signal resources may be flexible enough to occupy multiple non-contiguous REs and/or symbols/timeslots of the frame
Reference signal transmission can be triggered via Xn or F1 interface or some new air interface
CLI-RS resources may be defined to be generated independently by gNBs or each gNB requesting measurement coordination will generate it and convey it to neighboring gNB(s) via Xn or F1
the wireless base station gNB1 will perform SSB detection with all its neighbor cells (e.g., gNB2, gNB3 etc) and will find the strongest SSB index for each of its neighbor cells.

If data filed is not sent with IM-RS-r19 configuration 1 signal, then the wireless base station gNB1 may use Xn interface to set up resources for IM-RS-r19 configuration 2 transmissions with its neighbor cells.

If the wireless base station gNB1 detects a problem in receiving UL transmissions (e.g., sending high number of NACKs to UEs or measuring bad SNR/CQI in the UL), then it will trigger coordinated gNB-to-gNB measurement campaign with its neighboring gNBs (e.g., gNB2, gNB3 etc) via Xn or F1 interface. This may include:
The wireless base station gNB1 may use IM-RS-r19 configuration 1 signal to request coordination from the neighboring gNBs and if data field is sent with it then that will set up the resources for IM-RS-r19 configuration 2 signal.
The wireless base station gNB1 will not schedule any of its UEs on the resources (time and frequency) where neighboring gNBs will be transmitting their IM-RS-r19 signals
All the neighbor gNBs may transmit IM-RS-r19 signals either as time or code multiplex on the identified resources (time and frequency)
   the wireless base station gNB1 will either detect the neighbor cells (e.g. gNB2, gNB3 etc) by descrambling/correlating the received IM-RS-r19 reference signal using unique signatures/CLI-RS sequences of neighboring gNBs or will receive IM-RS-r19 signal from each neigboring gNB at the indicated time
During measurements gNB1 will cycle all its beams during the transmission of CLI reference signals from neighbor cells
the wireless base station gNB1 will perform sub-band and wideband interference measurement and will collect the interference per neighbor cell per symbol per timeslot per frame

Based on the measured sub-band and wideband interference levels, gNB1 can be configured to:
Schedule UL traffic in sub-bands and/or symbols that are reporting less gNB-to-gNB interference
gNB1 may coordinate with the neighboring gNBs via Xn or F1 or new interface
   Resource muting in certain sub-bands or REs, beam nulling or power reduction in certain neighbor gNB beams or power reduction during certain sub-bands per symbol

In processing operation 2810 of the flowchart 2800, the wireless base station 131 such as gNB1 (victim gNB) performs SSB detection such as detection of wireless beams transmitted by its neighbor wireless base stations gNBs (gNB2 and gNB3) to find the strongest wireless beams (SSB) of the neighboring gNBs such as wireless base station 132 and wireless base station 133. Accordingly, the SSB detection as discussed herein can include monitoring for the wireless beams transmitted by the wireless base station 132 and the wireless base station 133.

In processing operation 2820, via communications 181, the wireless base station 131 notifies the wireless base station 132 and the wireless base station 133 to implement the wireless interference testing information as indicated by CONFIGURATION 2. Note that if data filed is not part of IM-RS-r10 CONFIGURATION 1, then set up all the neighboring gNBs (gNB2, gNB3) with new IM-RS-r19 CONFIGURAITON 2 resources via Xn.

In processing operation 2830, via communications 182-1, the mobile communication device 121 communicates in an uplink to the wireless base station 131. Via communications 182-2, the mobile communication device 122 communicates in the uplink direction to the wireless base station 131. The wireless base station 131 experiences an inability to receive the uplink communications from the mobile communication devices 121 and 122 above a threshold level.

In processing operation 2835, in response to detecting the poor uplink performance between each of the mobile communication devices 121 and 122 and the wireless base station 131, the wireless base station 131 such as a Victim gNB transmits the wireless communications 184-1 to the wireless base station 132. The wireless base station 131 transmits wireless communications 184-2 to the wireless base station 133. The wireless communications 184-1 and 184-2 trigger a measurement campaign with neighboring gNBs (gNB2 AND gNB3), if it is generating NACKs>threshold or UL SINR/CQI levels<threshold. In one example, the communications 184-1 and 184-2 support setup of neighboring wireless base stations with the CONFIGURATION 2 (such as reference signal schedule information 145) if the wireless base stations 132 and 133 are not already configured.

Note that the trigger and communications 184 may be conveyed using any suitable interface such as via Xn or F1 or OTA using IM-RS-r19 signal, etc.

All the neighboring gNBs (gNB2 and gNB3) can be configured transmit IM-RS-r19 configuration 2 signal either time multiplexed or code multiplexed.

In processing operation 2840, none of the instances of mobile communication devices 121, 122, etc., are scheduled to transmit wireless signals.

In processing operation 2850, when the mobile communication devices 121 and 122 do not communicate in an uplink direction over specified wireless resources, the wireless base station 132 transmits wireless communications 185-1 such as one or more reference signals to the wireless base station 131 in accordance with the reference signal schedule information communicated to the wireless base station 132 in communications 184-1. Additionally, in processing operation 2850, the wireless base station 133 transmits wireless communications 185-2 such as one or more reference signals to the wireless base station 131 in accordance with the reference signal schedule information communicated to the wireless base station 133 in communications 184-2.

In processing operation 2860, the wireless base station 131 such as a Victim gNB measures sub-band and wideband interference levels on the indicated time and frequency resources of IM-RS CONFIGURATION 2 for each of the detected wireless beams (reference signals in communications 185-1 and communications 185-2) transmitted from the wireless base station 132 and the wireless base station 133.

In processing operation 2860, the wireless base station 131 such as Victim gNB averages the detected interference levels across different time (OFDM symbols/slots) and frequency resources for each gNB for each reference signal in the different wireless beams.

In processing operation 2865, based on the above measurement, the wireless base station 131 such as victim gNB1 will (re-)allocate the UEs in the time (OFDM symbols/slots) and frequency resources with minimum interference levels.

In processing operation 2870, the wireless base station 131 transmits communications 187, which includes a message transmitted to the neighboring gNBs via Xn or F1 or OTA interface to stop the wireless interference testing.

In processing operation 2875, the wireless base station 131 such as Victim gNB may also negotiate with interferring gNB(s) for resource muting in certain sub-bands or REs, beam nulling or power reduction in certain neighboring gNB(s) beams or power reduction during certain sub-bands per symbol. More specifically, via communications 188-1, the wireless base station 131 negotiates with the wireless base station 132 regarding discontinued use of the different wireless beams by the wireless base station 132 to reduce wireless interference. Via communications 188-2, the wireless base station 131 negotiates with the wireless base station 133 regarding discontinued use of the different wireless beams by the wireless base station 133. The negotiations include terminating any of one or more wireless beams use by the wireless base station 132 that were determined to cause interference to the wireless base station 131 in the prior processing operation 2860.

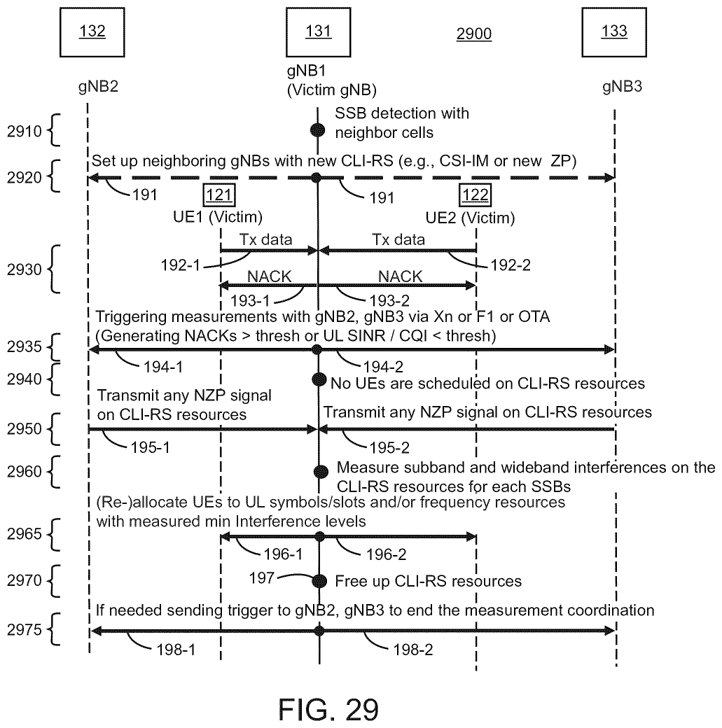

FIG. 29 is an example diagram illustrating wireless interference mitigation without changing TDD Uplink/Downlink Configurations (such as (gNB-to-gNB interference mitigation w/o designing gNB specific CLI-RS (i) without TDD Configuration Change and (ii) with coordination across neighboring gNBs) as discussed herein.

The following wireless interference test plan/configuration implemented by multiple wireless stations enables a victim wireless base station gNB (e.g., wireless base station 131 such as gNB1) to mitigate gNB-to-gNB interference without changing its TDD-UL-DL-Configuration; this is achieved potentially in coordination with neighboring gNBs (e.g. gNB2, gNB3), by (re-)allocating any affected UEs in UL sub-bands and or symbols to UL sub-bands and or symbols that the gNB1 measures to have less or lower gNB-to-gNB interference levels below a wireless interference threshold level.

The CLI resource information (e.g., CSI-SBFD-IM-Resource-r19 or ZP-CSI-RS-Resource using the (novel) ZP-CSI-RS-SBFD-ResourceMapping-r19 IE) may also be used for gNBs.

The wireless base station gNB1 can be configured to perform SSB detection with all its neighbor cells (e.g., gNB2, gNB3 etc) and will find the strongest SSB index for each of its neighbor cells, where SSB is Synchronization Signal Block (SSB) which contain Synchronization signals (Primary Synchronization Signal (PSS) and Secondary Synchronization Signal (SSS)) and Physical Broadcast Channel (PBCH), which contain Master Information Block (MIB) (containing vital information about gNB) and MIB contain information which uniquely identifies gNBs beams. Detecting SSB by the gNB will identified neighboring gNBs and beams of gNB to a receiver.

The wireless base station gNB1 can be configured to exchange the new CLI resource information (e.g., CSI-SBFD-IM-Resource-r19 or ZP-CSI-RS-Resource using the (novel) ZP-CSI-RS-SBFD-ResourceMapping-r19 IE), best SSBs of neighbor cell and time and duration of gNB-to-gNB measurement campaign, with all its neighbor cells via Xn or F1 or OTA.

The wireless base station 131 such as gNB1 can be configured to trigger coordinated gNB-to-gNB measurement campaign (a.k.a., wireless interference testing) with its neighboring gNBs (e.g., gNB2, gNB3 etc) via Xn or F1 interface, in response to detecting poor link quality associated with for example, the wireless base station 131 receiving UL transmissions with a high amount of wireless interference (e.g., the wireless base station 131 sends a high number of NACKs to UEs or the wireless base station 131 indicates a measure of poor link quality or bad SNR/CQI of the wireless base station 131 receiving communications in an uplink direction).

In this example, the wireless base station gNB1 can be configured to terminate use of or mute certain frequencies (REs) per symbol(s) in the UL of its own network, using the new CLI resource mapping.

During these CLI resources, in the UL symbols or slots, no UE connected to gNB1 will be allowed to transmit, allowing for wireless interference test measurements associated with the wireless base station 131 measuring wireless interference caused by other wireless base stations 132, 132, etc.

Note that a respective command to trigger neighboring gNBs (e.g., gNB2, gNB3) to operate in the wireless interference test mode may also contain information about the time when only one gNB (such as any of wireless base station 132, 133, etc.) is configured to transmit its any NZP type data (such as reference signal), while other gNBs will mute their transmissions, on the indicated CLI resources.

During the test mode, the wireless base station gNB1 can be configured to perform per neighbor cell sub-band and wideband interference measurement per symbol.

The wireless base station 131 such as gNB1 can be configured to also cycle its transmitted wireless beams (a.k.a., SSBs) to determine how wireless beams of other particular neighboring gNBs (e.g., gNB2, gNB3 etc) are interfering with the wireless beams transmitted by the wireless base station 131.

Based on the measured sub-band and wideband interference levels, gNB1 can be configured as follows:
wireless base station gNB1 can be configured to schedule UL traffic in sub-bands and/or symbols that are reporting less gNB-to-gNB interference.
wireless base station gNB1 may coordinate with the interfering neighbor gNBs (e.g., gNB2 or gNB3) via Xn or F1.
   Resource muting in certain sub-bands or REs, beam nulling or power reduction in certain neighbor cell beams or power reduction during certain REs per symbol.

In processing operation 2910, the wireless base station gNB1 (victim gNB) performs wireless beam (SSB) detection of wireless beams transmitted by the neighbor gNBs (gNB2 and gNB3) to find one or more strongest wireless beams transmitted by the neighboring wireless base stations 132 and 133. In other words, in processing operation 2910, the wireless base station 131 monitors for one or more wireless beams transmitted by the wireless base stations 132 and 133 and determines which transmitted wireless beams may cause interference.

In processing operation 2920, via communications 191, the wireless base station 131 configures the neighboring gNBs (wireless base station 132 such as gNB2, wireless base station 133 such as gNB3, etc.) with reference signal schedule information 145 (a.k.a., wireless interference test information) such as new CLI-RS configuration (e.g., CSI-SBFD-IM-Resource-r19 or ZP-CSI-RS-Resource using the (novel) ZP-CSI-RS-SBFD-ResourceMapping-r19 IE). In one example, the reference signal schedule information 145 (a.k.a., wireless configuration testing information) indicates a frequency and time or coding associated to be used by the wireless base station 132 and wireless base station 133 to transmit wireless reference signals.

In processing operation 2930, the wireless base station 131 monitors a performance of receiving uplink wireless communications 192-1 and 190 to 2 from the mobile communication devices 121 and 122. This can include the mobile communication device 121 transmitting uplink communications 192-1 to the wireless base station 131. The wireless base station 131 may experience wireless interference associated with receiving the communications 192-1. In the downlink direction, the wireless base station 131 transmits communications 193-1 (one or more NACKs) indicating failed receipt of receiving uplink communications from the mobile communication device 121. In response to detecting an uplink performance of receiving wireless communications from the communication devices 121 and/or 122 below a respective threshold level, the wireless base station 131 initiates execution of processing operation 2935 to test for wireless interference by other wireless stations transmitting in the network environment.

Note that the wireless base station can be configured to set up the neighboring gNBs for testing when a new gNB gets activated in the network or aperiodically on a need basis.

The wireless base station 131 can be configured to set up may be via Xn or F1 or OTA or any suitable interface.

In processing operation 2935, in response to detecting wireless interference associated with receiving wireless communications 192-1 and 1 9211 to, via transmission of communications 194-1 and 194-2, the wireless base station 131 such as a Victim gNB triggers a measurement campaign (a.k.a., wireless interference test mode) with neighboring gNBs (wireless base station 132 such as gNB2 and wireless base station 133 such as gNB3) during a condition in which wireless base station 131 detect that it is generating of NACKs>threshold or UL SINR/CQI levels<threshold via prior communications 192-1 and 193-1. In other words, the wireless base station 131 transmits the wireless communications 194-1 in response to detecting wireless interference potentially causing the inability of the wireless base station 131 to receive communications 192-1 above a performance threshold level. Alternatively, if the uplink quality of receiving communications of the mobile communication device 121 is below a threshold level, the wireless base station 131 initiates wireless interference testing. The wireless base station 131 performs wireless signal interference testing to determine if the wireless base station 132 or wireless base 133 cause the inability of the wireless base station 131 from receiving uplink communications from the mobile communication devices 121 or 122 during processing operation 2930.

In one example, if desired, the trigger command as indicated by the communications 194-1 and 194-2 specifies how the measurements are to be implemented.

Aperiodic (sent via DCI) or Semi-persistent (sent via MAC-CE) or periodic (sent via RRC).

For neighboring gNBs such as wireless base station 132 and wireless base station 133, the trigger notification in communications 194-1 and 194-2 can be configured to include the cell IDs of neighboring gNBs that were reported by victim UEs (such as mobile communication device 121 and mobile communication device 122).

In processing operation 2940, the wireless base station 131 temporarily terminates scheduling of all uplink communications from the mobile communication device 121 to the wireless base station 131. In other words, the wireless base station 131 temporarily terminates scheduling of uplink communications from the mobile communication device 121 to the wireless base station 131. The wireless base station also terminates uplink communications transmitted by the mobile communication device 122. Accordingly, based on the temporary termination, no UEs of the victim gNB such as wireless base station 131 are scheduled on the CLI-RS resources during testing of reference signals such and wireless beams from the wireless base station 132 and wireless base station 133 in processing operations 2950 and 2960.

In processing operation 2950, all of neighboring gNBs (gNB2 and gNB3) scheduled to transmit reference signals in accordance with the communications 191 transmit any NZP data on indicated CLI resources at given time and frequency as specified by the reference signal schedule information 145. In other words, during processing operation 2950, the wireless base station 132 transmits communications 195-1 as a nonzero power reference signal to the wireless base station 131. The wireless base station 133 transmits communications 195-2 as a nonzero power signal to the wireless base station 131.

In processing operation 2960, the wireless base station 131 such as a Victim gNB measures sub-band and wideband interference level associated with receiving the communications 195-1 and 195-2 such as CLI-RS (cross-link interference reference) at which time the communications 195-1 and the communications 195-2 are transmitted to the wireless base station 131. If desired, the communications 195-1 may be offset in time with respect to the communications 195-2. Recall that the wireless communications transmitted by the mobile communication devices 121 and 122 are temporarily terminated for the measurements in operation 2960. Thus, the wireless base station 131 is able to measure the reference signals transmitted by the wireless base station 132 and wireless base station 133 without interference from the mobile communication devices 121 and 122.

Further, in processing operation 2960, the wireless base station 131 and corresponding communication management resource 140 such as a Victim gNB can be configured to average the interference levels (as detected from communications 195-1, 195-2, etc.) across different time (OFDM symbols/slots) and frequency resources for each gNB for each reference signal transmitted in a respective wireless beams (SSB).

Based on the above measurements, in processing operation 2965, assume that the wireless base station 131 detects interference from processing operation 2960 above a threshold level for one or more of the transmitted beams. In response to this condition, the wireless base station 131 such as victim gNB allocates or reallocates wireless resources for use by the UEs (mobile communication devices 121, 122, etc.) in the time (OFDM symbols/slots) and frequency resources where minimal or interference below a threshold level was detected for wireless beams transmitted by the wireless base stations 132 and 133 during processing operation 2950.

In processing operation 2970, via transmission of communications 197, the wireless base station 131 transmits one or more messages to the neighboring gNBs via Xn or F1 or OTA or other suitable interface to stop or discontinue the coordination and implementation of the wireless testing mode as defined by the configuration information including reference signal schedule information 145.

In processing operation 2975, the wireless base station 131 such as a Victim gNB can be configured to also negotiate with interfering gNB(s) (such as any neighbor wireless base stations transmitting beams that cause wireless interference above a threshold level to the wireless base station 131) for resource muting in certain sub-bands or REs, beam nulling or power reduction in certain neighboring gNB(s) beams or power reduction during certain sub-bands per symbol. In other words, if the wireless base station 131 detects that a particular wireless beam transmitted by the wireless base station 132 is received by the wireless base station 132 above a threshold level, the wireless base station 131 can be configured to negotiate with the wireless base station 132 such that the wireless base station 132 terminates use of that beam causing the wireless interference. In such an instance, the channel associated with the terminated use of that interfering beam transmitted by the wireless base station 132 can be used to support communications between the wireless base station 131 and the mobile communication device 121.

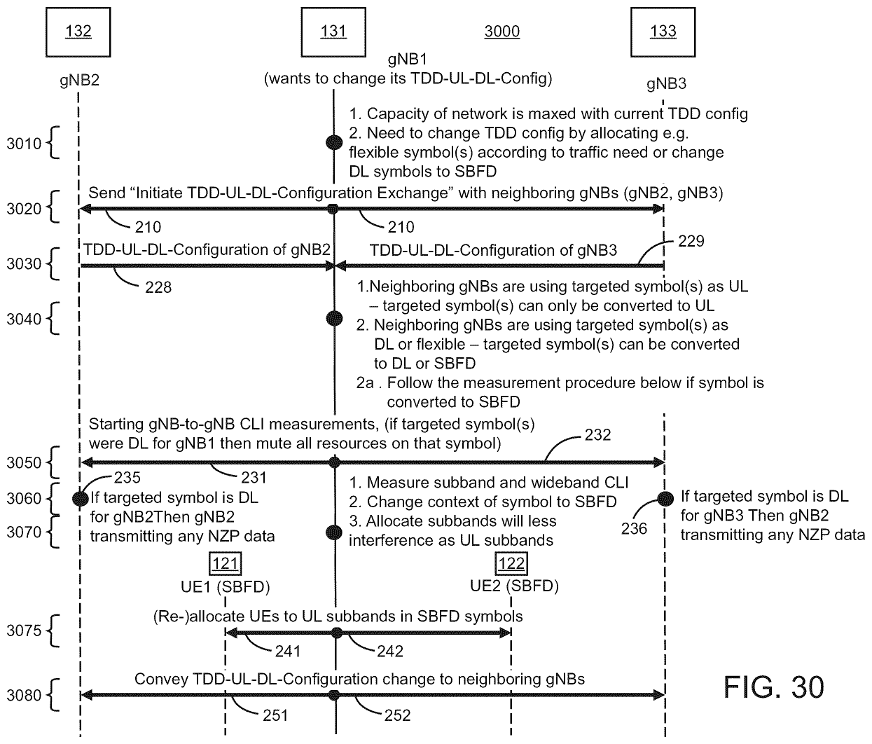

FIG. 30 is an example diagram illustrating modifying a TDD communication configuration (such as via Coordinated TDD-UL-DL Configuration change in flexible symbols) as discussed herein.

In this example, the use of an Xn interface may be enhanced to add a mechanism of requesting an exchange of latest TDD-UL-DL configurations from the neighboring gNBs.

For this proposal, “Initiate TDD-UL-DL-Configuration Exchange” may be used to implement the above two methods.

If a gNB1 such as wireless base station 131 desires to change its TDD-UL-DL-Configuration (e.g., change a flexible symbol or slot), then the gNB1 transmits a “Initiate TDD-UL-DL-Configuration Exchange” communication to all its neighboring gNBs (e.g., gNB2, gNB3 etc.).

In response to this condition, the neighboring gNBs send their currently used TDD-UL-DL-Configuration to gNB1.

If received TDD-UL-DL configurations indicate:
then if targeted flexible symbols or slots are still used as flexible, the wireless base station 131 such as gNB1 may decide based on the traffic load to use those flexible symbols or slots as either DL/SBFD, without causing any gNB-to-gNB CLI, respecitvely as UL, without causing UE-to-UE CLI
then if targeted flexible symbols or slots are being used as UL, those symbols or slots can only be converted as UL to avoid gNB-to-gNB interference in the network
then if Targeted flexible symbols or slots are being used as DL, those symbols and slots can be converted to DL or SBFD

To find the best UL sub-bands for SBFD symbols or slots, the wireless base station 131 such as gNB1 will:
Convert its antennas as receive antennas and will use all the REs (Resource Element) or specific REs as specified in CLI resources (e.g., CSI-SBFD-IM-Resource-r19) for measurements in targeted symbols—this is achieved as wireless base station 131 such as gNB1 has not scheduled any traffic on those symbols/slots
Measure sub-band and wideband interferences in the specific CLI resources of the targeted. Via the Flexible symbols or slots
the wireless base station 131 such as gNB1 converts the SBFD symbols or slots in the sub-bands that reported the lowest interference as UL sub-bands

As shown in flowchart 3000, in processing operation 3010, the wireless base station 131 such as gNB1 determines that it has reached max capacity of using available wireless resources to store uplink and downlink communications with the respective mobile communication devices while operating in a currently implemented TDD-UL-DL-Configuration. The wireless base station 131 in corresponding communication management resource 140 determines that it is necessary to change some of the flexible symbols or DL symbols to SBFD based on its traffic needs associated with the mobile communication devices receiving downlink wireless communications transmitted from the wireless base station to the mobile communication devices 121 and 122 or transmitting uplink wireless communications from the communication devices 121 and 122 to the wireless base station 131.

In processing operation 3020, the wireless base station such as gNB1 transmits wireless communications 210 including a command indicating to “Initiate TDD-UL-DL-Configuration Exchange.” The communications 210 are received by the wireless base station 132 (a.k.a., gNB2) and the wireless base station 133 (a.k.a., gNB3).

In response to receiving the communications 210, in processing operation 3030, the wireless base station 132 transmits communications 228 to the wireless base station 131. The communications 228 include or indicate a respective TDD-UL-DL-Configuration implemented by the wireless base station 132 and corresponding wireless network. Additionally, in response to receiving the communications 210, in processing operations 3030, the wireless base station 133 transmits communications 229 to the wireless base station 131. The communications 229 include or indicate a respective TDD-UL-DL-Configuration configuration implemented by the wireless base station 133 and corresponding wireless network.

In processing operation 3040, the wireless base station 131 such as gNB1 implements the following criteria to:
If neighboring gNBs are using targeted symbol(s) as UL then targeted symbols can only be converted to UL
If neighboring gNBs are using targeted symbols(s) as DL or flexible then targeted symbols can be converted to DL or SBFD
If there is no conflict with the neighbor gNBs to convert the targeted symbols to SBFD then the following procedure is carried out to find the optimum sub-band for UL allocation

In processing operation 3050, the wireless base station 131 transmits communications 231 and communications 232. The transmitted communications 231 notify the wireless base station 132 to implement a wireless interference testing mode in which the wireless base station 132 transmits wireless reference signals or nonzero power data to the wireless base station 131. The transmitted communications 232 notify the wireless base station 133 to implement a wireless interference testing mode (145) in which the wireless base station 133 transmits one or more wireless reference signals such as nonzero power data to the wireless base station 131. In one example, CSI-RS is a downlink-specific (DL) reference signal schedule for transmission as indicated by the reference signal schedule information 145. The NR (New Radio) standard defines zero-power (ZP) and non-zero-power (NZP) CSI-RSs.

In processing operation 3050, if TDD-UL-DL-Configuration defines targeted symbol(s) as DL, then the wireless base station 131 such as gNB1 will mute (terminate wireless communications over) all frequency resources on those symbols transmitted by the wireless base station 131 and wireless base station 132.

In processing operation 3060, if the targeted symbol is a downlink symbol associated with the wireless base station 132, then the wireless base station 132 transmits wireless reference signals (communications 235) such as nonzero power data. If the targeted symbol is a downlink symbol associated with the wireless base station 133, then the wireless base station 133 transmits wireless reference signals (communications 236) such as nonzero power data.

In processing operation 3070, the wireless base station 131 such as gNB1 measures gNB-to-gNB interference (sub-band and wideband) on the entire bandwidth of the targeted symbol(s) based on the wireless reference signals (communications 235 and communications 236) transmitted in processing operation 3060. Further, in processing operation 3070, the wireless base station 131 such as gNB1 can be configured to allocate channels to the mobile communication devices 121 and 122 where there is less interference detected to UL sub-bands of SBFD. The wireless base station 131 such as gNB1 updates its TDD-UL-DL-Configuration with the context of symbol changed to SBFD.

In processing operation 3075, via communications 241 and 242 transmitted from the wireless base station 131, the wireless base station 131 allocates different wireless channels and corresponding SBFD symbols to support wireless communications between the wireless base station 131 and the mobile communication devices 121 and 122.

In processing operation 3080, the wireless base station such as gNB1 conveys the information of its new TDD-UL-DL-Configuration to neighboring gNBs via transmission of communications 251 to the wireless base station 132 and transmission of the communications 252 to the wireless base station 133.

Accordingly, techniques herein include a method comprising: at a first wireless base station (131) implementing a first time division duplex configuration to communicate with first mobile communication devices (121, 122): receiving notification (221) of a second time division duplex configuration implemented by a second wireless base station (132) to communicate with second mobile communication devices; monitoring wireless communications (235) transmitted by the second wireless base station (132); and based on monitoring, implementing a third time division duplex configuration (251) as a substitute to implementing the first time division duplex configuration.

In one example, monitoring the wireless communications (235) transmitted by the second wireless base station (132) includes: measuring (3070) wireless interference associated with receiving a reference signal wireless communication (235) from the second wireless base station (132).

In another example, based on the monitoring of communications (235), the wireless base station (131) and corresponding communication management resource 140 modify the first time division duplex configuration (210) to produce the third time division duplex configuration (251) used by the first wireless base station.

As previously discussed, the wireless base station 131 can be configured to transmit (via communications 251) the third time division duplex configuration to the second wireless base station (132).

Yet further, in accordance with the third time division duplex configuration, the first wireless base station (131) communicates (241, 242) with the first mobile communication devices (121, 122) to schedule uplink communications to the first wireless base station.

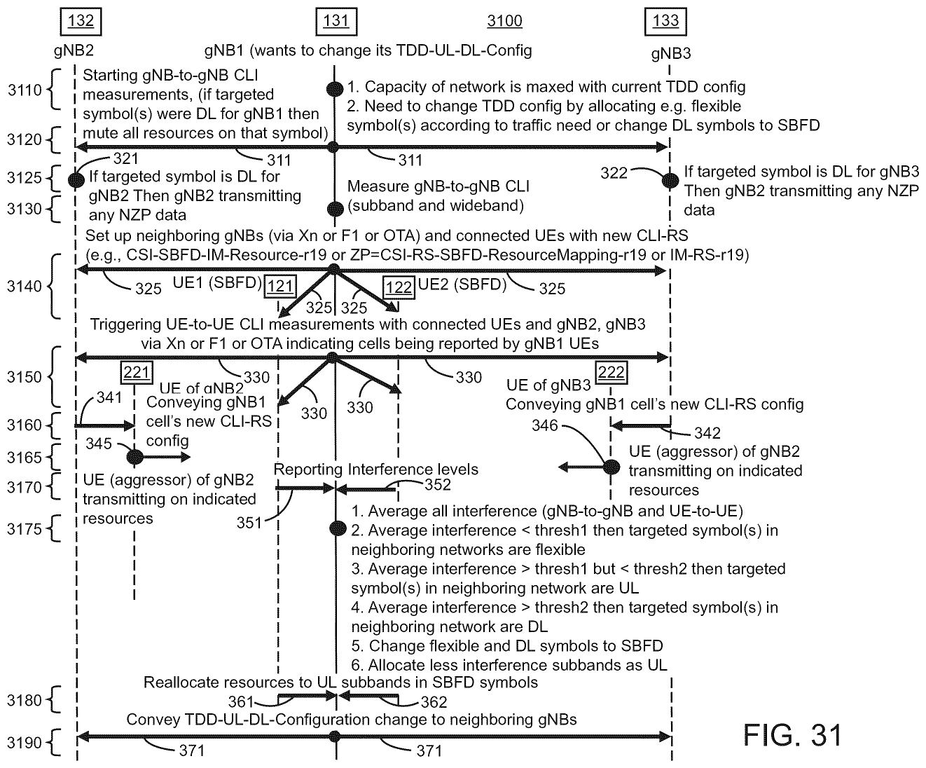

FIG. 31 is an example diagram illustrating modifying a TDD communication configuration (such as via Coordinated TDD-UL-DL Configuration change in flexible symbols) as discussed herein.

In this example, in a case where there is no Xn interface with neighboring gNB(s) (e.g., wireless base stations) belonging to a different wireless network service operator, then the flowchart 3000 may not accurately reflect the CLI that may occur in all the networks. The following flowchart 3100 in FIG. 31 can be used to coordinate TDD-UL-DL configuration with neighboring gNBs having Xn interface.

Further in this example, the wireless base station 131 such as gNB1 configure the targeted flexible symbols or slots (that need to change context) as DL and signal to all the connected UEs using TDD-UL-DL-ConfigDedicated or TDD-UL-DL-ConfigCommon.

The wireless base station 131 such as gNB1 can be configured to convey new CLI reference signal schedule information (e.g., CSI-SBFD-IM-Resource-r19 or ZP-CSI-RS-Resource using the (novel) ZP-CSI-RS-SBFD-ResourceMapping-r19 IE), to all the connected UEs in the network environment.

The wireless base station 131 such as gNB1 can be configured to configure CLI resources of targeted flexible symbols or slots such that all the REs are configured as ZP (zero Power).

Note further that all of the connected UEs may be asked to report back sub-band as well as wideband UE-to-UE CLI measurements using indicated CLI resources in the targeted symbols during an UL slot.

The wireless base station such as gNB1 may also configure its antennas as receive antennas during the targeted flexible symbols or slots and will perform sub-band as well as wideband gNB-to-gNB CLI measurements on CLI resources.

The UE-to-UE and gNB-to-gNB interference data corresponding to flexible symbols or slots is averaged and compared against pre-defined thresholds.

If a reported interference level is below a threshold (e.g., half the max UE transmit power) then it means neighbor gNBs are keeping those symbols or slots as flexible. The inquiring gNB can be configured to convert the symbols or slots to DL or SBFD or UL.

If a reported interference level is above a threshold (e.g., half of max UE transmit power) and below another threshold (e.g., max UE transmit power+1 dBm) then it may be inferred that neighboring gNBs are using those symbols or slots as UL. Inquiring gNB may only convert the symbols or slots as UL.

If a reported interference level is above a threshold (e.g., max UE transmit power+1 dBm) then it may be inferred that neighboring gNBs are using those symbols or slots as DL. Inquiring gNB may convert the symbols or slots as DL or SBFD.

Further, if a measuring gNB converts the flexible symbol as SBFD symbol, then sub-bands that reported less interference will be configured as UL sub-bands.

The TDD-UL-DL configuration maybe updated and conveyed to all the neighboring gNBs with whom there exist an Xn interface.

More specifically, as shown in flowchart 3100, in processing operation 3110, the wireless base station 131 such as gNB1 determined that it has reached max capacity associated with scheduling uplink and downlink communications while operating in its current TDD-UL-DL-Configuration. In such an instance, the wireless base station 131 and corresponding communication management resource 140 decides to change one or more of the flexible symbols or DL symbols to SBFD symbols based on its traffic needs. In processing operation 3120, to protect the network (such as the network including wireless base station 131 and the network including wireless base station 132 or other network) from interference, the wireless base station 131 such as gNB1 transmits communications 311 to notify the wireless base station 132 and wireless base station 133 of the start of implementing a wireless interference testing mode such as including gNB-to-gNB CLI measurements (if targeted symbol is DL then mute all frequency resources on that symbol). The wireless base station 131 also implements its antenna hardware in a receive mode for subsequent processing operation 3130 to receive wireless signals transmitted in subsequent communications 321 (from wireless base station 132) and communications 322 (from the wireless base station 133) to the wireless base station 131 in processing operation 3125.

In one example, in accordance with communications 311, if the wireless base station 132 such as gNB2 and the wireless base station 133 such as gNB3 are using targeted symbols as DL, then the wireless base station 132 such as gNB2 and the wireless base station 133 such as gNB3 transmit their respective NZP data in the targeted symbols from the wireless base station 132 to the wireless base station 133. As previously discussed, in processing operation 3130, the wireless base station 131 measures cross-link interference associated with receiving the communications 321 and 322 transmitted by the wireless base station 132 and the wireless base station 133.

After the gNB-to-gNB measurement is complete in processing operation 3130, the wireless base station 131 such as gNB1 starts the UE-to-UE measurement with the neighboring gNBs and all connected UEs in processing operation 3140. In processing operation 3140, the wireless base station 131 transmits communications 325 to multiple wireless stations such as wireless base station 132, wireless base station 133, mobile communication device 121, mobile communication device 122, etc.

In one example, the communications 325 specify a new cross-link interference tests mode such as including reference signal schedule information 145, such as indicating CLI-RS resources (e.g., CSI-SBFD-IM-Resource-r19 or ZP-CSI-RS-SBFD-ResourceMapping-r19 or IM-RS-19), which is transmitted to the wireless base station 132 such as gNB2 and a wireless base station 133 such as gNB3 via any suitable communication interface such as Xn or F1 or OTA.

Subsequent to distribution of the cross-link interference testing mode information in communications 325, in processing operation 3150, the wireless base station 131 such as gNB1 transmits communications 330 to wireless stations including the wireless base station 132, wireless base station 133, mobile communication device 121, mobile communication device 122, etc. Transmission of the communications 330 triggers the wireless stations to start the UE-to-UE measurements as further discussed below in accordance with reference signal schedule information 145 in communications 325. The communications 330 can be transmitted over any suitable any suitable interface such as Xn or F1 or OTA, where the cross-link interference test mode information can be configured to indicate the cells of the neighboring gNBs that are reported by mobile communication devices 121 and 122 in communication with the wireless base station 131.

Upon receiving the trigger as indicated by the communications 330, the wireless base station 132 such as gNB2 and wireless base station 133 such as gNB3 respond (in processing operation 3160) by further conveying notification (such as communications 345 and communications 346) of the new CLI-RS configuration (such as cross-link interference test mode information indicating how to perform wireless interference testing) to the UEs (mobile communication device 221, mobile communication device 222, etc.) in the one or more cell of interest as identified by the wireless base station 131.

For example, in response to receiving the notification to implement cross-link interference measurements as indicated by the communications 330, the wireless base station 132 transmits the communications 341 including the cross-link interference test mode information or reference signal scheduling information to the mobile communication device 221 in processing operation 3160. In a similar manner, in response to receiving the notification to implement cross-link interference measurements as indicated by the communications 330, the wireless base station 133 transmits the communications 342 including the cross-link interference test mode information or reference signal scheduling information to the mobile communication device 222 in processing operation 3160. Accordingly, the mobile communication device 221 and mobile communication device 222 are scheduled to transmit wireless reference signals in processing operation 3165.

As further shown, in processing operation 3165, the mobile communication device 221 transmits wireless communications 345 at a time and over a corresponding one or more wireless channels indicated by the communications 341. In a similar manner, in processing operation 3165, the mobile communication device 222 transmits wireless communications 346 at a time and over one or more corresponding wireless channels indicated by the communications 342. In one example, all of the UEs (mobile communication device 221, mobile communication device 222, etc.) start transmitting (communications 345 and 346) reference signals as any NZP data on the resources (time and frequency) of the new CLI-RS or transmit a reference signal e.g. IM-RS-r19 configuration 2 type.

At a time and frequency (channel) as indicated by the communications 341, in processing operation 3165, the mobile communication device 121 monitors the one or more wireless reference signals transmitted in the communications 345 from the mobile communication device 221. In one example, all of the UEs connected to gNB1 (UE1 and UE2) measure the UE-to-UE wireless interference associated with receiving the communications 345 and 346 and generate a corresponding wireless interference report associated with receiving reference signals.

In processing operation 3170, the mobile communication device 121 transmits wireless communications 351 to the wireless base station 131. The wireless communications 351 include a report or feedback indicating wireless interference associated with the mobile communication device 121 receiving the wireless communications 345 transmitted from the mobile communication device 221.

Additionally, in processing operation 3170, the mobile communication device 122 transmits wireless communications 352 to the wireless base station 131. The wireless communications 352 include a report feedback indicating wireless interference associated with the mobile communication device 122 receiving the wireless communications 346 transmitted from the mobile communication device 222.

In processing operation 3175, the wireless base station 131 performs one or more of the following operations:
the wireless base station 131 can be configured to average all the CLI data (UE-to-UE and gNB-to-gNB) for each targeted symbol.
if the average CLI<thresh1, then it is considered that the neighboring gNBs are still using target symbols as flexible—in such an instance, targeted symbols can be converted to SBFD symbols.
if the average CLI>thresh1, but CLI<thresh2, then it is considered that the neighboring gNBs are using target symbols as UL—in such an instance, the wireless base station 131 can only use targeted symbol as UL.
if the average CLI>thresh2, then it is considered that the neighboring gNBs are using target symbols as DL—in such an instance, the targeted symbols can be converted by the wireless base station to SBFD symbols.
if the wireless base station 131 such as gNB1 converts the targeted DL or flexible symbol to SBFD symbols, the wireless base station 131 and corresponding communication management resource 140 allocate sub-bands with less interference as UL for those symbols.

In processing operation 3180, via communications 361 and 362, the wireless base station 131 reallocates or allocates use of wireless resources (a.k.a., timeslots and channels) to uplink wireless channels for the identified SBFD symbols.

In processing operation 3190, via communications 371, the wireless base station 131 such as gNB1 transmits a notification of and details of the updated time division duplex configuration TDD-UL-DL-Configuration newly implemented by the wireless base station 131 to the wireless base station 132. Additionally, in processing operation 3190, via communications 371, the wireless base station 131 such as gNB1 transmits a notification of and details of the updated time division duplex configuration TDD-UL-DL-Configuration newly implemented by the wireless base station 131 to the wireless base station 133. Accordingly, the wireless base stations 132 and 133 are now aware of the updated time division duplex configuration implemented by the wireless base station 131 to communicate with the mobile communication devices 121 and 122.

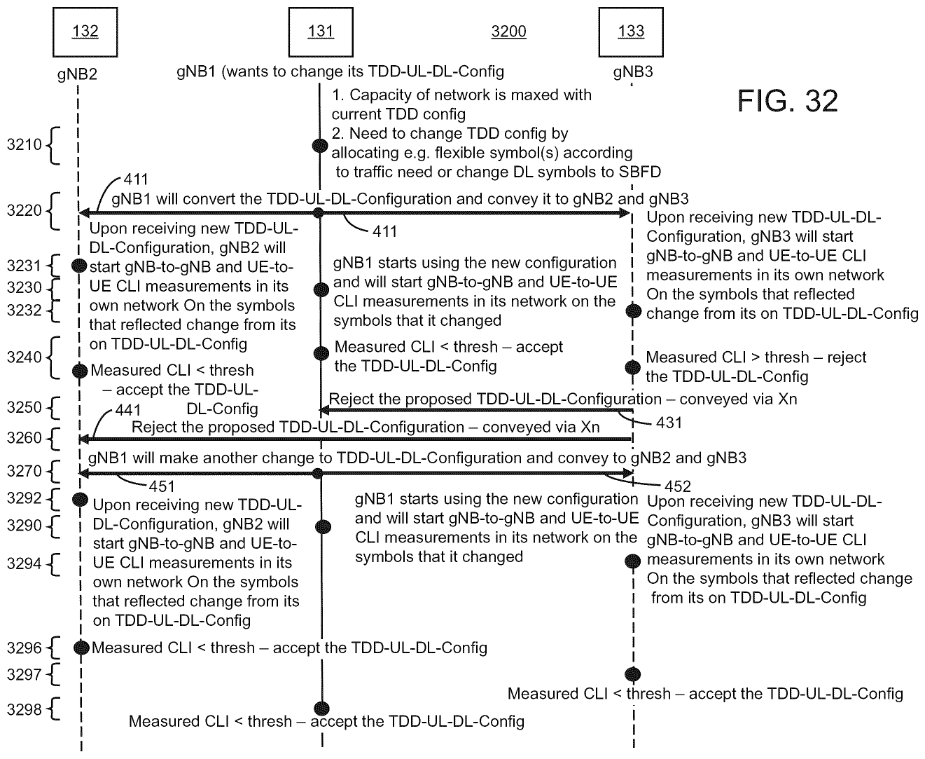

FIG. 32 is an example diagram illustrating modification of a TDD (Time Division Duplex) communication configuration (such as via Coordinated TDD-UL-DL Configuration change in flexible symbols) as discussed herein.

In this example, if the wireless base station 131 such as gNB1 sends a message to wireless base station 132 such as gNB2, where the message includes its “Intended DL-UL Configuration NR” IE, and that intended configuration presents a conflict with one or more resources (symbols or slots) of gNB2, then the wireless base station 131 such as gNB1 sends a message to wireless base station 132 such as gNB2 with an “Intended DL-UL Configuration NR”, where the wireless base station 131 is aware of the time division duplex configuration TDD-UL-DL-Config implemented by the wireless base station 132 such as gNB2.

Additionally, if the wireless base station 131 such as gNB1 proposes to use the resource as DL, while the wireless base station 132 such as gNB2 already uses the resource as UL, the wireless base station 131 such as gNB1 should immediately start transmitting in that resource as proposed and should instruct its UE to measure UE-to-UE CLI in that resource.

If wireless base station 131 such as gNB1 proposes to use the resource as UL, while the wireless base station 132 such as gNB2 already uses the resource as DL, the wireless base station 131 such as gNB1 should immediately use that resource as UL, and measure the level of gNB-to-gNB interference caused by wireless base station 132 such as gNB2. If a better result is desired, the wireless base station 131 such as gNB1 can be configured to instruct its own UEs to mute on those resources.

When the wireless base station 132 such as gNB2 receives a message from a wireless base station 131 such as gNB1, wherein the message includes an “Intended DL-UL Configuration NR”:
If the wireless base station 132 such as gNB2 already uses as an uplink resource that is proposed by the wireless base station 131 such as as being a downlink, then the wireless base station 132 such as gNB2 measures the level of gNB-to-gNB CLI that wireless base station 131 such as gNB1 will be causing.
If wireless base station 132 such as gNB2 already uses a respective wireless resource such as a time slot as DL, a resource that wireless base station 131 such as gNB1 proposed as UL, then wireless base station 132 such as gNB2 instructs its UE to measure UE-to-UE CLI in that resource.

Note: As described above, each gNB and its UE are making the measurements without any specialized RS from the other gNB. If desired, the assistance of the neighbor can be used, as described in other embodiments.

After having concluded the measurements, the wireless base station 132 such as gNB2 will know whether the CLI (UE-to-UE and/or gNB-to-gNB) level is acceptable or not. If unacceptable, wireless base station 132 would reject the proposal, otherwise it would accept the proposal.

For its part, the wireless base station 131 such as gNB1, will also know the effect of the proposed time division duplex configuration change. So even if wireless base station 132 such as gNB2 decides to accept the proposal, the wireless base station 131 such as gNB1 may have decided that the effect on its own network (itself, or its UE) is too much, and if that were the case, would propose to revert back to the previous configuration (which was working fine), or propose yet another configuration.

To avoid a situation where two gNBs end up engaged in a back and fourth disagreement, wasting network processing time, the following operations can be implemented to resolve any conflict:
Stop negotiations after x number of attempts.
Stop negotiations after a time duration x, without having agreement.
a respective wireless base station such as gNB that is experiencing heavy traffic such as (UL or DL resource requests) or experiences a cell capacity that is reaching its maximum, that wireless base station will win the conflict.

Now more specifically, in processing operation 3210, the wireless base station 131 such as gNB1 detects that it has reached max capacity of transmitting or receiving wireless communications while operating in current first time division duplex configuration TDD-UL-DL-Configuration. In such an instance, the wireless base station 131 and corresponding communication management resource 140 determines the need to change some of the flexible symbols or DL symbols to SBFD symbols based on its traffic needs.

In processing operation 3220, via communications 411, the wireless base station 131 such as gNB1 provides notification to the wireless base station 132 and wireless base station 133 regarding a proposed change in its (wireless base station 131) time division duplex configuration TDD-UL-DL-Configuration. The communications 411 include a first proposed time division duplex configuration, including changes with respect to the initial time division duplex configuration implemented by the wireless base station 131 prior to or during processing operation 3210.

In processing operation 3230, the wireless base station 131 such as gNB1 starts using the first proposed time-division duplex communication configuration (as indicated by communications 411) and initiates gNB-to-gNB and UE-to-UE CLI measurements in its network. This may include the wireless base station 131 transmitting a further notification to the wireless base station 132 and the wireless base station 133 indicating implementation of the first proposed time division duplex communication configuration and the need to perform wireless interference testing.

Further, in processing operation 3231, the wireless base station 132 such as gNB2 initiates gNB-to-gNB and UE-to-UE CLI measurements in its own network in response to receiving the new (first proposed) TDD-UL-DL-Configuration and wireless interference test request in communications 411 from the first wireless base station 131.

In processing operation 3232, the wireless base station 133 such as gNB3 initiates gNB-to-gNB and UE-to-UE CLI measurements in its own network in response to receiving the new (first proposed) TDD-UL-DL-Configuration and wireless interference test request in communications 411 from the first wireless base station 131.

In processing operation 3240, the wireless base station 132 such as gNB2 detects that overall CLI level as detected by the wireless base station 132 and processing operation 3231 is less than a respective threshold for the proposed time division duplex change (as indicated by communications 411) and therefore is willing to accept the first proposed time division duplex configuration in communications 411 from the wireless base station 131 such as gNB1. The wireless base station 133 perform similar operation in processing operation 3232.

In processing operation 3240, the wireless base station 131 such as gNB1 detects that overall CLI level<threshold in the proposed time division duplex change locations and therefore is willing to accept the first proposed time division duplex configuration in communications 411 from the wireless base station 131 such as gNB1.

In processing operation 3240, assume that the wireless base station 133 such as gNB3 detects that overall CLI level>threshold in the proposed time division duplex change locations and therefore is not willing to accept the first proposed time division duplex configuration in communications 411 from the wireless base station 131 such as gNB1. The wireless base station 133 therefore decides to reject the first proposed time division duplex configuration as indicated by the communications 411.

Further, in processing operation 3250, via communications 431, in response to the wireless base station 133 such as gNB3 detecting that overall measured CLI level at the wireless base station 133 is greater than a threshold (processing operation 3240) in locations where the first proposed time division duplex configuration is intended to be used or was used, the wireless base station 133 notifies the wireless base station 131 of the rejection of the first proposed time division duplex configuration received from the wireless base station 131 in communications 411.

More specifically, in response to detecting that the measured CLI level is greater than the threshold in processing operation 3240, the wireless base station 133 transmits the communications 431 to notify the wireless base station 131 of the rejection of the proposed time division duplex configuration in communications 411 in processing operation 3250. As further shown, in processing operation 3260, the wireless base station 133 transmits the communications 441 to notify the wireless base station 132 of the rejection of the first proposed time division duplex configuration associated with the wireless base station 131 in communications 411.

Note that the communications from the wireless base station can be transmitted over Xn interface or other suitable interface.

In processing operation 3270, in response to receiving the rejection of the first proposed time division duplex configuration as indicated in communications 431, the wireless base station 131 such as gNB1 generates and transmits a second proposed time division duplex configuration (further modification to the original time division duplex configuration or first proposed time division duplex configuration) and transmits that second proposed configuration (modified TDD-UL-DL-Configuration) to both the second wireless base station 132 such as gNB2 and the third wireless base station 133 such as gNB3. Thus, in processing operation 3270, the wireless base station 131 transmits wireless communications 451 including the second proposed time division duplex configuration to the wireless base station 132. The wireless base station 131 transmits wireless communications 452 including the second proposed time division duplex configuration to the wireless base station 133.

Via further processing operations, all three gNBs such as wireless base stations 131, 132, and 133, start gNB-to-gNB and UE-to-UE CLI measurements in their networks.

In processing operation 3290, the wireless base station 131 implements the second proposed time division duplex configuration to support wireless communications with its mobile communication devices 121, 122, etc.

Further, in processing operation 3292, the wireless base station 132 such as gNB2 initiates gNB-to-gNB and UE-to-UE CLI measurements in its own network in response to receiving the new (second proposed) TDD-UL-DL-Configuration and wireless interference test request from the first wireless base station 131.

In processing operation 3294, the wireless base station 133 such as gNB3 initiates gNB-to-gNB and UE-to-UE CLI measurements in its own network in response to receiving the new (second proposed) TDD-UL-DL-Configuration and wireless interference test request from the first wireless base station 131.

For example, in processing operation 3296, the second wireless base station 132 measures an amount of wireless interference associated with the first wireless base station 131 and corresponding network implementing the second proposed time division duplex configuration as transmitted during operations 3270 in communications 451. In processing operation 3296, the second wireless base station 132 detects that the amount of wireless interference to the wireless base station 132 as caused by the wireless base station 131 implementing the second proposed time division duplex configuration is less than a threshold level. In such an instance, the wireless base station 132 accepts the second proposed time division duplex configuration. The acceptance by the wireless base station 132 may include the wireless base station 132 transmitting a respective wireless communication to the wireless base station 131 indicating the acceptance of the second proposed time division duplex configuration.

In processing operation 3297, the wireless base station 133 measures an amount of wireless interference associated with the first wireless base station 131 and corresponding network implementing the second proposed time division duplex configuration as transmitted during operations 3290. In processing operation 3297, the wireless base station 133 detects that the amount of wireless interference to the wireless base station 133 and corresponding wireless network as caused by the wireless base station 131 implementing the second proposed time division duplex configuration is less than a threshold level. In such an instance, the wireless base station accepts the second proposed time division duplex configuration. The acceptance by the wireless base station 133 may include the wireless base station 133 transmitting a respective wireless communication to the wireless base station 131 indicating the acceptance of the second proposed time division duplex configuration.

As further shown, in processing operation 3298, wireless base station 131 measures an amount of wireless interference associated with the first wireless base station 131 implementing the second proposed time division duplex configuration as transmitted during operations 3290 and communications 451 and 452. In processing operation 3298, the wireless base station 133 detects that the amount of wireless interference from other wireless base stations to the wireless base station 131 implementing the second proposed time division duplex configuration is less than a threshold level. In such an instance, the wireless base station 131 accepts the second proposed time division duplex configuration as well.

Accordingly, all of the gNBs find that overall CLI in their networks<thresh and all the gNBs accept the TDD-UL-DL-Configuration change.

If there is a situation when there is conflict that cannot be resolved between the networks (first network including the wireless base station 131, second network including the wireless base station 132, third network including the wireless base station 133), then following mechanism may be introduced to resolve the conflict.

For example, there may be a delay in the configuration change request for X duration or slots.

A respective gNB with maximum traffic load e.g., capacity reaching max based on the current TDD-UL-DL-Configuration wins and other gNB will have to accept the changes.

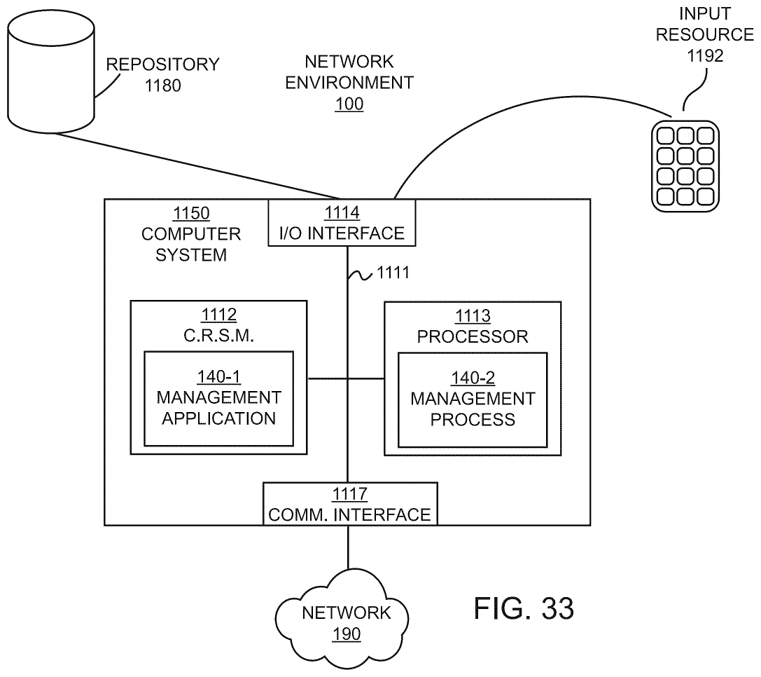

FIG. 33 is an example block diagram of a computer system for implementing any of the operations as previously discussed according to examples herein.

Any of the resources (such as wireless stations, communication management resource associated with any of wireless base station 131, wireless base station 132, wireless base station 133, . . . , mobile communication device 121, mobile communication device 122, mobile communication device 221, mobile communication device to 222, . . . etc.) as discussed herein can be configured to include computer processor hardware and/or corresponding executable instructions to carry out the different operations as discussed herein via computer system 1150.

As shown, computer system 1150 of the present example includes an interconnect 1111 coupling computer readable storage media 1112 such as a non-transitory type of media (or more generally, computer readable hardware which can be any suitable type of hardware storage medium in which digital information can be stored and retrieved), a processor 1113 (computer processor hardware), I/O interface 1114, and a communications interface 1117.

I/O interface(s) 1114 supports connectivity to repository 1180 and input resource 1192.

Computer readable storage medium 1112 (such as computer readable hardware or other suitable entity) can be any hardware storage device such as memory, optical storage, hard drive, floppy disk, etc. In one example, the computer readable storage medium 1112 stores instructions and/or data.

As shown, computer readable storage media 1112 can be encoded with management application 140-1 (e.g., including instructions) to carry out any of the operations as discussed herein.

During operation of one example, processor 1113 accesses computer readable storage media 1112 via the use of interconnect 1111 in order to launch, run, execute, interpret or otherwise perform the instructions in management application 140-1 stored on computer readable storage medium 1112. Execution of the management application 140-1 produces management process 140-2 to carry out any of the operations and/or processes as discussed herein.

Those skilled in the art will understand that the computer system 1150 can include other processes and/or software and hardware components, such as an operating system that controls allocation and use of hardware resources to execute management application 140-1.

In accordance with different examples, note that computer system may reside in any of various types of devices, including, but not limited to, a mobile computer, a personal computer system, wireless station, connection management resource, a wireless device, a wireless access point, a access point, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1150 may reside at any location or can be included in any suitable resource in any network environment to implement functionality as discussed herein. In one example, the control system 1150 can include or be implemented in virtualization environments such as the cloud.

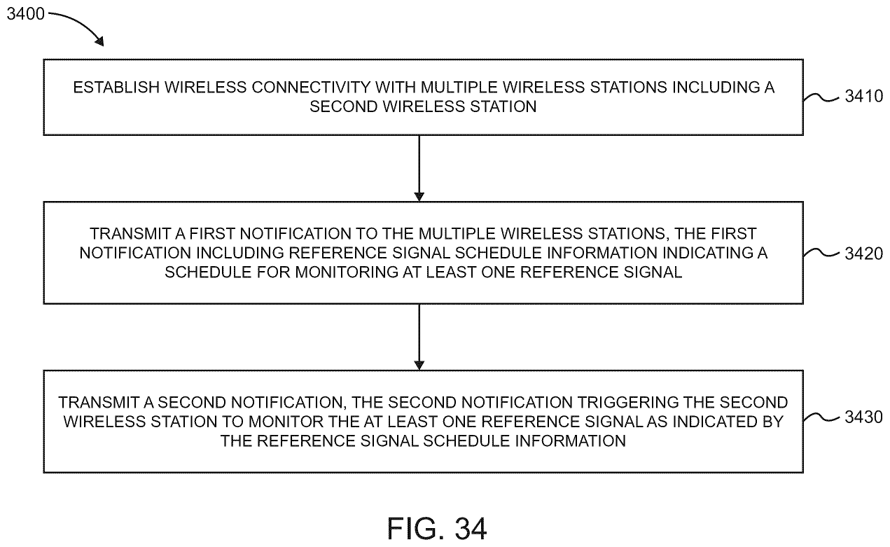

Functionality supported by the different resources will now be discussed via flowchart in FIG. 34. Note that the steps in the flowcharts below can be executed in any suitable order.

FIG. 34 is a flowchart 3400 illustrating an example method according to examples. Note that flowchart 3400 overlaps/captures general concepts as discussed herein.

In processing operation 3410, a first wireless station establishes wireless connectivity with multiple wireless stations including a second wireless station.

In processing operation 3420, the first wireless station transmits a first notification to the multiple wireless stations, where the first notification includes reference signal schedule information indicating a schedule for monitoring at least one reference signal.

In processing operation 3430, the first wireless station transmits a second notification, where the second notification triggers the second wireless station to monitor the at least one reference signal as indicated by the reference signal schedule information.

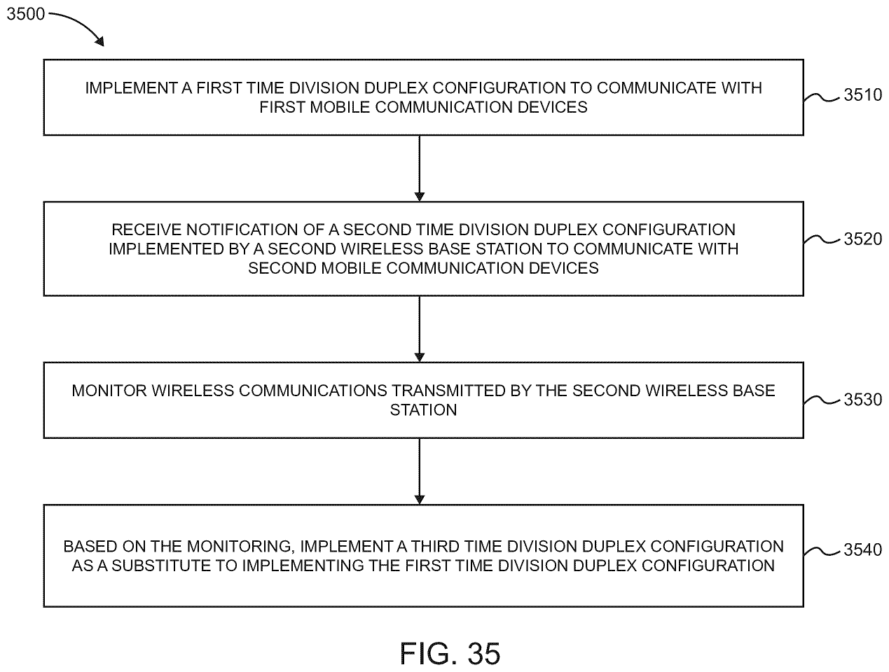

FIG. 35 is a flowchart 3500 illustrating an example method according to examples. Note that flowchart 3500 overlaps/captures general concepts as discussed herein.

In processing operation 3510, the first wireless base station implements a first time division duplex configuration to communicate with first mobile communication devices.

In processing operation 3520, the first wireless base station receives notification of a second time division duplex configuration implemented by a second wireless base station used to communicate with second mobile communication devices.

In processing operation 3530, the first wireless base station monitors wireless communications transmitted by the second wireless base station.

In processing operation 3540, based on the monitoring, the first wireless base station generates and then implements a third time division duplex configuration as a substitute to implementing the first time division duplex configuration.

Note again that techniques herein are well suited to facilitate mitigation of wireless interference in a network environment as well as support changing one or more time division duplex uplink/downlink configurations to support better use of available wireless resources. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

1. A method comprising:
at a first wireless station:
establishing wireless connectivity with multiple wireless stations including a second wireless station;
transmitting a first notification to the multiple wireless stations, the first notification including reference signal schedule information indicating a schedule for monitoring at least one reference signal; and
transmitting a second notification, the second notification triggering the second wireless station to monitor the at least one reference signal as indicated by the reference signal schedule information.

2. The method as in claim 1, wherein the at least one reference signal includes a first wireless reference signal, the method further comprising:
from the first wireless station, transmitting the first wireless reference signal to the second wireless station as indicated by the schedule.

3. The method as in claim 1 further comprising:
in response to the first wireless station transmitting the at least one reference signal, receiving feedback from the second wireless station, the feedback indicating a magnitude of wireless interference associated with the second wireless station receiving the at least one reference signal.

4. The method as in claim 3 further comprising:
comparing the magnitude of wireless interference to a threshold level; and
in response to detecting that the magnitude of the wireless interference is greater than the threshold level, modifying wireless resources allocated to support a wireless connection between the first wireless station and the second wireless station.

5. The method as in claim 1 further comprising:
transmitting the second notification in response to detecting that a performance of a wireless communication link between the first wireless station and the second wireless station falls below a threshold level.

6. The method as in claim 5 further comprising:
determining the performance of the wireless communication link between the first wireless station and the second wireless station based on feedback from the second wireless station indicating an inability of the second wireless station to receive wireless communications transmitted in a downlink direction from the first wireless station to the second wireless station.

7. The method as in claim 5 further comprising:
determining the performance of the wireless communication link between the first wireless station and the second wireless station based on feedback from the second wireless station, the feedback indicating a wireless power level at which the first wireless station receives wireless communications from the first wireless base station.

8. The method as in claim 1, wherein the reference signal schedule information indicates a frequency and time that the first wireless station is scheduled to transmit a first wireless reference signal of the at least one reference signal from the first wireless station.

9. The method as in claim 1, wherein the reference signal schedule information indicates an encoding configuration assigned to transmitting the at least one reference signal.

10. The method as in claim 1, wherein the at least one reference signal is scheduled for transmission via at least one symbol scheduled for transmission from the first wireless station; and
wherein the reference signal schedule information indicates timing of transmitting the at least one symbol in a timeslot.

11. The method as in claim 1, wherein the reference signal schedule information indicates multiple different channels to be monitored by the second wireless station for detection of the at least one reference signal, the method further comprising:
in response to transmitting the second notification, receiving feedback from the second wireless station, the feedback indicating different levels of wireless interference associated with the second wireless station receiving at least one reference signal in the multiple different channels.

12. The method as in claim 11 further comprising:
in response to determining a first channel of the multiple different channels at which the second wireless station receives the at least one reference signal below an interference threshold level, allocating the first channel to support a first wireless communication link between the first wireless station and the second wireless station.

13. The method as in claim 1, wherein the multiple wireless stations include a third wireless station and a fourth wireless station; and
wherein the reference signal schedule information indicates a schedule for transmitting the at least one reference signal from the fourth wireless station to the second wireless station.

14. The method as in claim 13, wherein the first wireless station is a first wireless base station in a first wireless network;
wherein the second wireless station is a first mobile communication device wirelessly connected to the first wireless base station in the first wireless network;
wherein the third wireless station is a second wireless base station in a second wireless network; and
wherein the fourth wireless station is a second mobile communication device, the second mobile communication device wirelessly connected to the second wireless base station in the second wireless network.

15. The method as in claim 14, wherein the second wireless base station is operative to transmit the reference signal schedule information to the second mobile communication device; and
wherein the transmission of the second notification prompts the second wireless base station to notify the second mobile communication device to transmit the at least one reference signal from the second mobile communication device to the first mobile communication device in a manner as indicated by the reference signal schedule information.

16. The method as in claim 15 further comprising:
at the first wireless base station, receiving feedback from the first mobile communication device, the feedback indicating a magnitude of wireless interference associated with the first mobile communication device receiving the at least one reference signal transmitted from the second mobile communication device.

17. The method as in claim 16, wherein the at least one reference signal is transmitted over a first wireless channel, the method further comprising:
in response to detecting that the magnitude of the wireless interference is above a threshold level, communicating with the second wireless base station to negotiate discontinued use of the first wireless channel by the second wireless base station.

18. The method as in claim 16, wherein the at least one reference signal is transmitted over a first wireless channel, the method further comprising:
in response to detecting that the magnitude of the wireless interference is above a threshold level, allocating use of a second wireless channel by the first mobile communication device as a substitute to the first wireless channel.

19. A system comprising:
communication management hardware operative to:
establish wireless connectivity with multiple wireless stations including a second wireless station;
transmit a first notification to the multiple wireless stations, the notification including reference signal schedule information indicating a schedule for monitoring at least one reference signal; and
transmit a second notification, the second notification triggering the second wireless station to monitor the at least one reference signal as indicated by the reference signal schedule information.

20. The system as in claim 19, wherein the at least one reference signal includes a first wireless reference signal, the communication management hardware further operative to:
from the first wireless station, transmit the first wireless reference signal to the second wireless station as indicated by the schedule.

21. The system as in claim 19, wherein the communication management hardware is further operative to:
in response to the first wireless station transmitting the at least one reference signal, receive feedback from the second wireless station, the feedback indicating a magnitude of wireless interference associated with the second wireless station receiving the at least one reference signal.

22. The system as in claim 21, wherein the communication management hardware is further operative to:
compare the magnitude of wireless interference to a threshold level; and
in response to detecting that the magnitude of the wireless interference is greater than the threshold level, modifying wireless resources allocated to support a wireless connection between the first wireless station and the second wireless station.

23. The system as in claim 19, wherein the communication management hardware is further operative to:
transmit the second notification in response to detecting that a performance of a wireless communication link between the first wireless station and the second wireless station falls below a threshold level.

24. The system as in claim 23, wherein the communication management hardware is further operative to:
determine the performance of the wireless communication link between the first wireless station and the second wireless station based on feedback from the second wireless station indicating an inability of the second wireless station to receive wireless communications transmitted in a downlink direction from the first wireless station to the second wireless station.

25. The system as in claim 23, wherein the communication management hardware is further operative to:
determine the performance of the wireless communication link between the first wireless station and the second wireless station based on feedback from the second wireless station, the feedback indicating a wireless power level at which the first wireless station receives wireless communications from the first wireless base station.

26-37. (canceled)

38. A method comprising:
at a first wireless base station implementing a first time division duplex configuration to communicate with first mobile communication devices:
receiving notification of a second time division duplex configuration implemented by a second wireless base station to communicate with second mobile communication devices;
monitoring wireless communications transmitted by the second wireless base station; and
based on the monitoring, implementing a third time division duplex configuration as a substitute to implementing the first time division duplex configuration.

39-50. (canceled)
